(19) United States
(12) Patent Application Publication
(10) Pub. No.: US 2024/0309920 A1
(43) Pub. Date: Sep. 19, 2024

(54) OPPOSED PISTON TYPE DISC BRAKE DEVICE

(71) Applicant: AKEBONO BRAKE INDUSTRY CO., LTD., Tokyo (JP)

(72) Inventors: Sean SUZUKI, Tokyo (JP); Kenichi Shimamura, Tokyo (JP); Ryo Otake, Tokyo (JP)

(73) Assignee: AKEBONO BRAKE INDUSTRY CO., LTD., Tokyo (JP)

(21) Appl. No.: 18/603,749

(22) Filed: Mar. 13, 2024

(30) Foreign Application Priority Data
Mar. 15, 2023 (JP) 2023-040416

(51) Int. Cl. F16D 65/00; F16D 55/00; F16D 55/228; F16D 65/18; F16D 121/04

(52) U.S. Cl. CPC F16D 65/0068; F16D 55/228; F16D 65/183; F16D 2055/0016; F16D 2121/04

(57) ABSTRACT

An opposed piston type disc brake device includes: a caliper including an inner body including an inner cylinder, and an outer body including an outer cylinder; and a communication pipe disposed around the caliper and connecting the inner cylinder and the outer cylinder. The communication pipe includes a pipe body, a pair of flare nuts, and a cover tube which covers a part of the pipe body and is in contact with the caliper with a fastening margin, the cover tube being made of an elastic material. The cover tube does not have the fastening margin with respect to the caliper in a central axis direction of each of the flare nuts.

### CROSS-REFERENCE TO RELATED APPLICATIONS

This application is based on Japanese Patent Application No. 2023-040416 filed on Mar. 15, 2023, the contents of which are incorporated herein by way of reference.

### TECHNICAL FIELD

The present invention relates to an opposed piston type disc brake device.

### BACKGROUND

Disc brake devices are widely used for braking automobiles and motorcycles. At the time of braking by the disc brake device, a pair of pads disposed on both axial sides of a rotor rotating together with a wheel are pressed against both axial side surfaces of the rotor by a piston. There are disc brake devices having various structures in the related art, but since an opposed piston type disc brake device including pistons on both axial sides of a rotor can obtain a stable braking force, usage examples have been increased in recent years.

FIGS. 42 to 45 show an opposed piston type disc brake device 100 having a structure in the related art described in JP2022-1782A (Patent Literature 1).

The opposed piston type disc brake device 100 includes a caliper 102 that is disposed so as to cover a disc-shaped rotor 101 rotating together with a wheel from a radially outer side and is fixed to a vehicle body, and a pair of pads 103a and 103b that are supported to be movable in an axial direction with respect to the caliper 102 and disposed on both axial sides of the rotor 101.

Regarding the opposed piston type disc brake device 100, unless otherwise specified, an axial direction, a circumferential direction, and a radial direction refer to an axial direction, a circumferential direction, and a radial direction of the rotor 101 rotating together with the wheel.

The caliper 102 includes an inner body 104 disposed axially inward of the rotor 101 and an outer body 105 disposed axially outward of the rotor 101. The “axially inner side” refers to an upper side in FIG. 42 and a lower side in FIG. 43, which are a center side in a width direction of a vehicle in a state in which the opposed piston type disc brake device 100 having a structure in the related art is assembled to the vehicle, and the “axially outer side” refers to a lower side in FIG. 42 and an upper side in FIG. 43, which are an outer side in the width direction of the vehicle in a state in which the opposed piston type disc brake device 100 is assembled to the vehicle.

The inner body 104 includes a plurality of inner cylinders 106. An inner piston 107 is fitted to each of the inner cylinders 106 in a manner of being displaceable in the axial direction.

The outer body 105 includes a plurality of outer cylinders 108. An outer piston 109 is fitted to each of the outer cylinders 108 in a manner of being displaceable in the axial direction.

The inner body 104 includes an inner oil passage hole (not shown) therein in order to supply brake oil to and discharge the brake oil from a deep portion of the inner cylinder 106. The inner oil passage hole communicates with the deep portion of each of the plurality of inner cylinders 106.

The outer body 105 includes an outer oil passage hole (not shown) therein in order to supply the brake oil to and discharge the brake oil from a deep portion of the outer cylinder 108. The outer oil passage hole communicates with a deep portion of each of the plurality of outer cylinders 108.

End portions on one circumferential side of the inner oil passage hole and the outer oil passage hole are connected to each other by a communication pipe 110. Accordingly, the inner oil passage hole and the outer oil passage hole communicate with each other. End portions on the other circumferential side of the inner oil passage hole and the outer oil passage hole are closed by bleeder screws 111.

The inner body 104 and the outer body 105 are axially coupled by a rotation-in-side coupling portion 112, a rotation-out-side coupling portion 113, and an intermediate coupling portion 114.

In the opposed piston type disc brake device 100 having the structure in the related art, the one circumferential side corresponds to a rotation-in side when the vehicle moves forward, and the other circumferential side corresponds to a rotation-out side when the vehicle moves forward.

During braking, the brake oil is fed from a master cylinder to the inner oil passage hole via a brake hose connected to the inner body 104. Accordingly, the inner piston 107 is pushed out from the inner cylinder 106 in the axial direction, and the pad 103a supported by the inner body 104 is pressed against an axially inner surface of the rotor 101. Further, the brake oil is fed from the inner oil passage hole to the outer oil passage hole through the communication pipe 110. Accordingly, the outer piston 109 is pushed out from the outer cylinder 108 in the axial direction, and the pad 103b supported by the outer body 105 is pressed against an axially outer surface of the rotor 101. As a result, the rotor 101 is strongly sandwiched by the pair of pads 103a and 103b from both the axial sides, and the braking of the vehicle is performed.

The communication pipe 110 is disposed around the caliper 102 so as to cover one circumferential side portion of the caliper 102 from the one circumferential side. The communication pipe 110 includes a pipe body 115, a pair of flare nuts 116a and 116b, and a cover tube 117.

The pipe body 115 is made of metal and has a substantially U-shape as viewed in the radial direction.

The pair of flare nuts 116a and 116b are provided at end portions on both sides of the pipe body 115 in a manner of being rotatable relative to the pipe body 115 in a state in which respective central axes Oa and Ob thereof arranged substantially parallel to each other. One flare nut 116a is provided at an end portion on one side of the pipe body 115, and is screwed and connected to one circumferential side portion of the inner body 104. The other flare nut 116b is provided at an end portion on the other side of the pipe body 115, and is screwed and connected to one circumferential side portion of the outer body 105.

In the opposed piston type disc brake device 100 having the structure in the related art, the respective central axes Oa and Ob of the pair of flare nuts 116a and 116b extend along the circumferential direction (left-right direction in FIGS. 42 and 43). Therefore, central axis directions of the flare nuts 116a and 116b substantially coincide with the circumferential direction.

The cover tube 117 is made of an elastic material and has a cylindrical shape. The cover tube 117 covers an intermediate portion of the pipe body 115.

The cover tube 117 is in contact with the caliper 102 with a fastening margin in a state in which the one flare nut 116a is screwed and connected to the inner body 104 and the other flare nut 116b is screwed and connected to the outer body 105.

Specifically, the cover tube 117 is in contact with a first contact surface 118 and a second contact surface 119 provided in the rotation-in-side coupling portion 112 constituting the caliper 102 with fastening margins. The first contact surface 118 has a planar shape and faces the one circumferential side. On the other hand, the second contact surface 119 has a planar shape, disposed substantially perpendicular to the first contact surface 118, and faces the radially outer side.

In the opposed piston type disc brake device 100 having the structure in the related art, the cover tube 117 made of the elastic material is brought into contact with the caliper 102 with the fastening margin, thereby suppressing the communication pipe 110 from floating from the caliper 102 and suppressing a gap from being generated between the cover tube 117 and the caliper 102. Accordingly, a portion of a surface of the caliper 102 which is covered with the cover tube 117 and is not coated is suppressed from being exposed, and the communication pipe 110 is suppressed from interfering with a wheel disposed around the opposed piston type disc brake device 100.
Patent Literature 1: JP2022-1782A

When the flare nuts 116a and 116b are screwed and connected to the inner body 104 and the outer body 105, the flare nuts 116a and 116b are respectively rotated around the central axes Oa and Ob, and the communication pipe 110 is moved in the circumferential direction that substantially coincides with the central axis directions of the flare nuts 116a and 116b so as to approach the caliper 102. Specifically, the communication pipe 110 is moved to the other circumferential side, which is a proximal side with respect to the caliper 102.

However, in the opposed piston type disc brake device 100 having the structure in the related art, in order to bring the cover tube 117 into contact with the first contact surface 118 facing the one circumferential side with the fastening margin, it is necessary to increase an elastic deformation amount of the cover tube 117 with respect to the first contact surface 118 when the communication pipe 110 is moved to the other circumferential side. Therefore, tightening torque of each of the flare nuts 116a and 116b increases, and efficiency of an assembly work of the opposed piston type disc brake device 100 may decrease.

Increasing the fastening margin of the cover tube 117 with respect to the first contact surface 118 is advantageous in terms of suppressing the floating of the communication pipe 110, but if the fastening margin is excessively increased, there is a possibility that an excessive tensile stress is applied to a connection portion between the communication pipe 110 and the caliper 102. As a result, there is a possibility of causing problems that sealing performance of the connection portion is lowered and a defective fraction of the opposed piston type disc brake device 100 is increased.

The present invention has been made to solve the above problems, and an object of the present invention is to provide an opposed piston type disc brake device capable of suppressing a communication pipe from floating with respect to a caliper, and improving efficiency of an assembly work and reducing a tensile stress applied to a connection portion between the communication pipe and the caliper compared to the related art.

### SUMMARY

An opposed piston type disc brake device according to one aspect of the present invention includes: a caliper including an inner body including an inner cylinder, and an outer body including an outer cylinder; and a communication pipe disposed around the caliper and connecting the inner cylinder and the outer cylinder. The communication pipe includes a pipe body, a pair of flare nuts which are provided on end portions of the pipe body on both sides in a manner of being rotatable relative to the pipe body in a state in which central axes of the flare nuts are arranged substantially parallel to each other, and which are respectively screwed and connected to the inner body and the outer body, and a cover tube which covers a part of the pipe body and is in contact with the caliper with a fastening margin, the cover tube being made of an elastic material. The cover tube does not have the fastening margin with respect to the caliper in a central axis direction of each of the flare nuts.

In the opposed piston type disc brake device according to the aspect of the present invention, a gap may be provided between the cover tube and the caliper in the central axis direction of the flare nut.

In the opposed piston type disc brake device according to the aspect of the present invention, the cover tube may be pressed against the caliper only in one predetermined direction other than the central axis direction of the flare nut.

In the opposed piston type disc brake device according to the aspect of the present invention, the cover tube may be pressed against the caliper in a direction substantially orthogonal to the central axis direction of the flare nut.

In the opposed piston type disc brake device according to the aspect of the present invention, the central axis direction of the flare nut may substantially coincide with a circumferential direction, and the cover tube may be pressed against a surface of the caliper facing radially outward.

In the opposed piston type disc brake device according to the aspect of the present invention, the central axis direction of the flare nut may substantially coincide with a circumferential direction, and the cover tube may be pressed against a surface of the caliper facing radially inward.

In the opposed piston type disc brake device according to the aspect of the present invention, the caliper may further include a coupling portion that couples a circumferential end portion of the inner body to a circumferential end portion of the outer body, and the cover tube may be pressed against the coupling portion.

In the opposed piston type disc brake device according to the aspect of the present invention, a surface of the caliper with which the cover tube is in contact while having the fastening margin, may be a flat surface.

In the opposed piston type disc brake device according to the aspect of the present invention, the central axis of each of the pair of flare nuts and the surface of the caliper with which the cover tube is in contact while having the fastening margin, may be arranged substantially parallel to each other.

In the opposed piston type disc brake device according to the aspect of the present invention, the caliper may include a protuberance at a portion in contact with the cover tube.

In the opposed piston type disc brake device according to the aspect of the present invention, the cover tube may include a protuberance at a portion in contact with the caliper.

In the opposed piston type disc brake device according to the aspect of the present invention, the protuberance may protrude in a direction substantially orthogonal to the central axis direction of the flare nut.

In the opposed piston type disc brake device according to the aspect of the present invention, the protuberance may be disposed on an orthogonal plane that passes through a position where distances to the respective central axes of the pair of flare nuts are equal to each other in a virtual plane including the central axes of the pair of flare nuts and that is orthogonal to the virtual plane.

### BRIEF DESCRIPTION OF DRAWINGS

FIG. 1 is a front view showing an opposed piston type disc brake device according to a first embodiment.

FIG. 2 is a plan view showing the opposed piston type disc brake device according to the first embodiment.

FIG. 3 is a side view of the opposed piston type disc brake device according to the first embodiment as viewed from a rotation-in side.

FIG. 4 is a side view of the opposed piston type disc brake device according to the first embodiment as viewed from a rotation-out side.

FIG. 5 is a bottom view showing the opposed piston type disc brake device according to the first embodiment.

FIG. 6 is a rear view showing the opposed piston type disc brake device according to the first embodiment.

FIG. 7 is a cross-sectional view taken along a line A-A in FIG. 2.

FIG. 8 is a cross-sectional view taken along a line B-B in FIG. 1 which passes through three cylinder centers disposed on a radially outer side.

FIG. 9 is a partially enlarged view of FIG. 1.

FIG. 10A is a partially enlarged view of FIG. 5, and FIG. 10B is a view in which a communication pipe is omitted from FIG. 10A.

FIG. 11A is a partially enlarged view of FIG. 7, and FIG. 11B is a view in which the communication pipe is omitted from FIG. 11A.

FIG. 12 is a partially enlarged view of FIG. 8.

FIG. 13 is a perspective view showing the opposed piston type disc brake device according to the first embodiment as viewed from an axially outer side, the radially outer side, and the rotation-out side.

FIG. 14 is a perspective view showing the opposed piston type disc brake device according to the first embodiment as viewed from an axially inner side, the radially outer side, and the rotation-out side.

FIG. 15 is a perspective view showing the opposed piston type disc brake device according to the first embodiment as viewed from the axially outer side, a radially inner side, and the rotation-out side.

FIG. 16 is a perspective view showing the opposed piston type disc brake device according to the first embodiment as viewed from the axially inner side, the radially inner side, and the rotation-out side.

FIGS. 17A to 17F are views showing the communication pipe taken out from the opposed piston type disc brake device according to the first embodiment, in which FIG. 17A is a front view, FIG. 17B is a plan view, FIG. 17C is a bottom view, FIG. 17D is a right side view, FIG. 17E is a left side view, and FIG. 17F is a rear view.

FIG. 18 is a cross-sectional view taken along a line C-C in FIG. 17A.

FIG. 19 is a view illustrating a direction of pressing the communication pipe against a caliper after the communication pipe is taken out from the opposed piston type disc brake device according to the first embodiment.

FIG. 20 is a view corresponding to FIG. 1, showing a second embodiment.

FIG. 21 is a view corresponding to FIG. 2, showing the second embodiment.

FIG. 22 is a view corresponding to FIG. 3, showing the second embodiment.

FIG. 23 is a view corresponding to FIG. 6, showing the second embodiment.

FIG. 24 is a view corresponding to FIG. 7, showing the second embodiment.

FIG. 25 is a partially enlarged view of FIG. 20, showing the second embodiment.

FIG. 26A is a partially enlarged view of FIG. 21, and FIG. 26B is a view in which a coupling pipe is omitted from FIG. 26A.

FIG. 27A is a partially enlarged view of FIG. 24, and FIG. 27B is a view in which the coupling pipe is omitted from FIG. 27A.

FIG. 28 is a perspective view showing an opposed piston type disc brake device according to the second embodiment as viewed from an axially outer side, a radially outer side, and a rotation-in side.

FIG. 29 is a perspective view showing the opposed piston type disc brake device according to the second embodiment as viewed from an axially inner side, the radially outer side, and the rotation-in side.

FIG. 30 is a perspective view showing the opposed piston type disc brake device according to the second embodiment as viewed from the axially outer side, a radially inner side, and the rotation-in side.

FIG. 31 is a view corresponding to FIG. 19, showing the second embodiment.

FIG. 32 is a view corresponding to FIG. 4, showing a third embodiment.

FIGS. 33A and 33B are views corresponding to FIGS. 10A and 10B, showing the third embodiment.

FIGS. 34A and 34B are views corresponding to FIGS. 11A and 11B, showing the third embodiment.

FIG. 35 is a schematic view viewed in a direction of arrow D in FIG. 34A, showing the third embodiment.

FIG. 36 is a view corresponding to FIG. 35, showing a modification of the third embodiment.

FIG. 37 is a view corresponding to FIG. 4, showing a fourth embodiment.

FIGS. 38A and 38B are views corresponding to FIGS. 10A and 10B, showing the fourth embodiment.

FIGS. 39A and 39B are views corresponding to FIGS. 11A and 11B, showing the fourth embodiment.

FIG. 40 is a schematic view viewed in a direction of arrow E in FIG. 39A, showing the fourth embodiment.

FIG. 41 is a view corresponding to FIG. 40, showing a modification of the fourth embodiment.

FIG. 42 is a plan view showing an opposed piston type disc brake device having a structure in the related art.

FIG. 43 is a bottom view showing the opposed piston type disc brake device having the structure in the related art.

FIG. 44 is a cross-sectional view taken along a line F-F in FIG. 42.

FIG. 45 is a partially enlarged view of FIG. 44.

### DESCRIPTION OF EMBODIMENTS

### First Embodiment

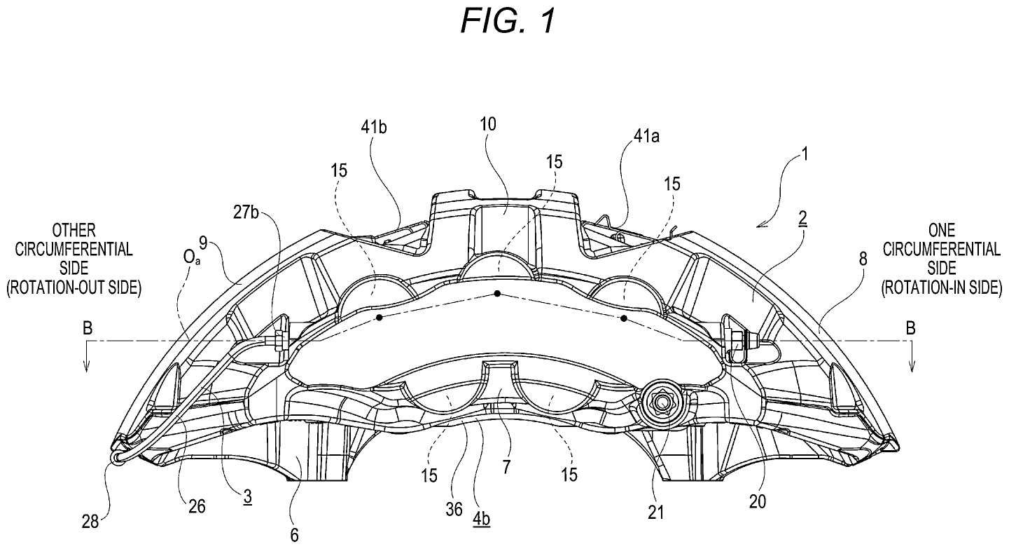

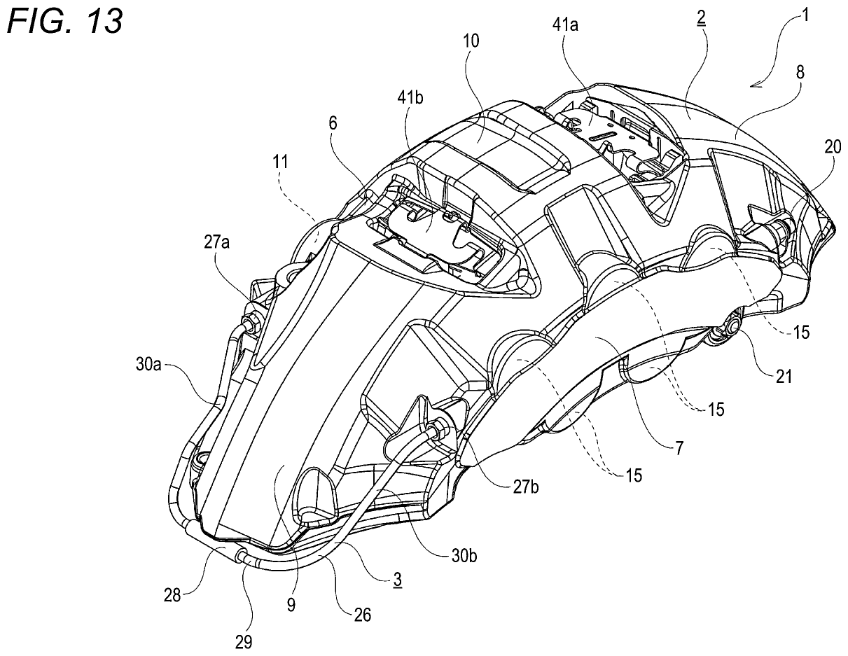

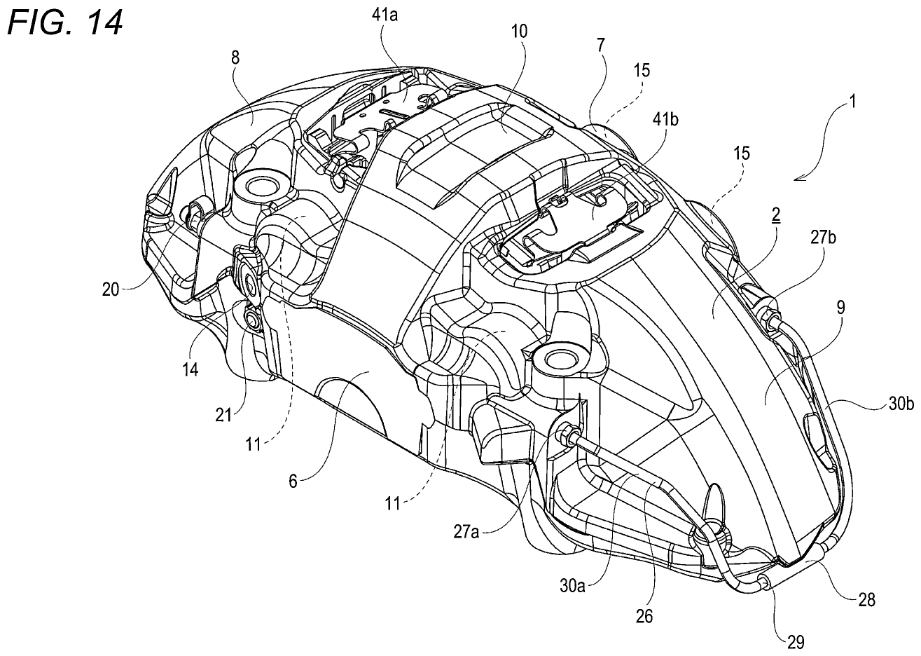

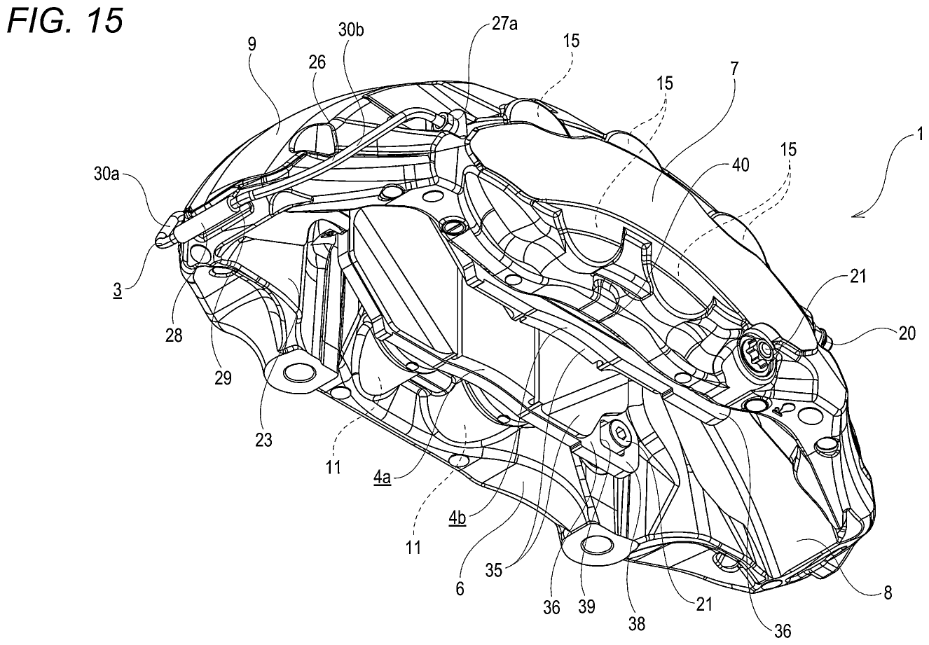

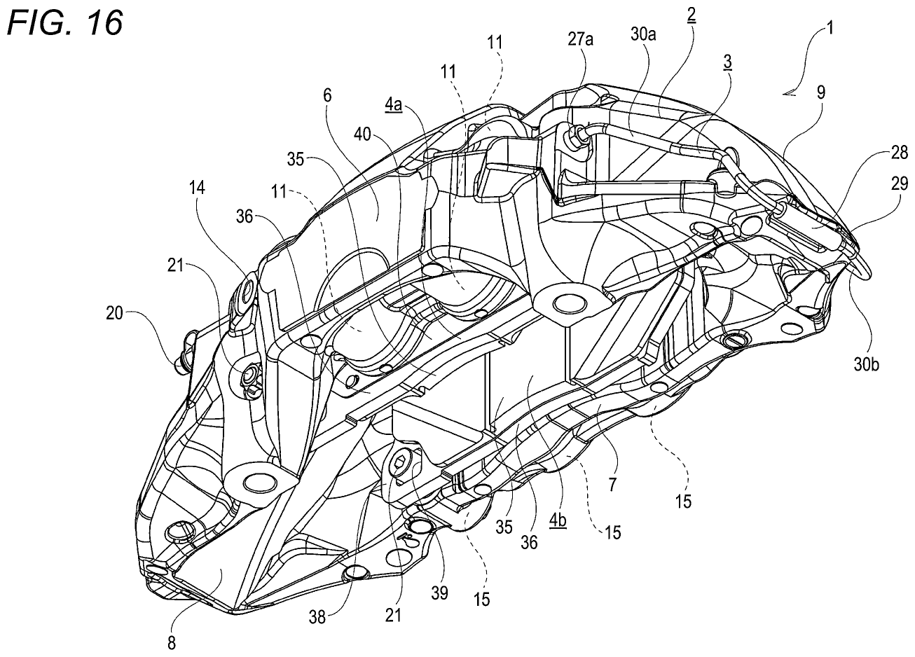

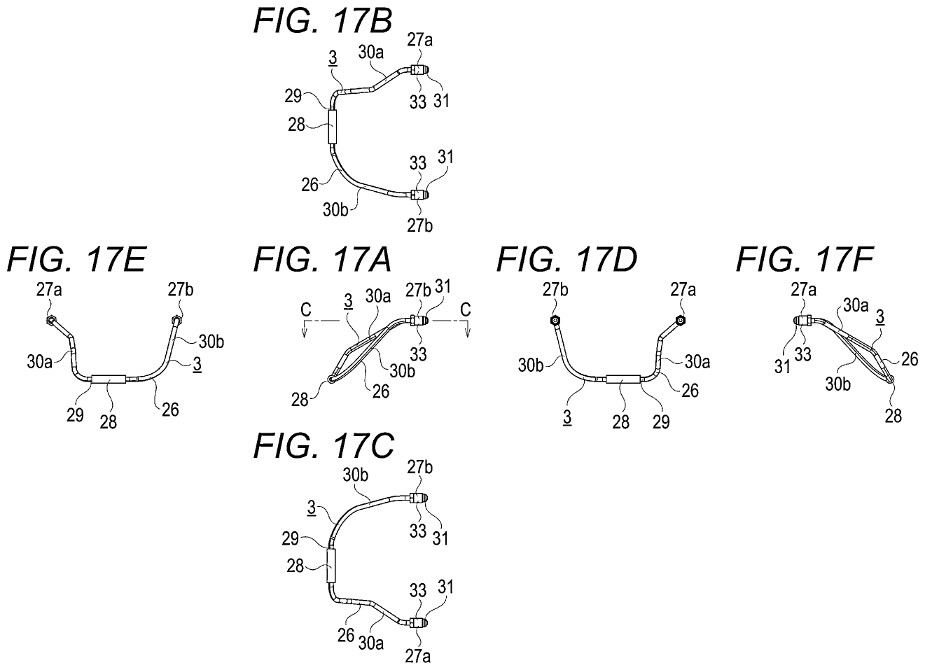

A first embodiment will be described with reference to FIGS. 1 to 19.

An opposed piston type disc brake device 1 according to this example is used for braking an automatic vehicle, and includes a caliper 2, a communication pipe 3, and a pair of pads 4a and 4b.

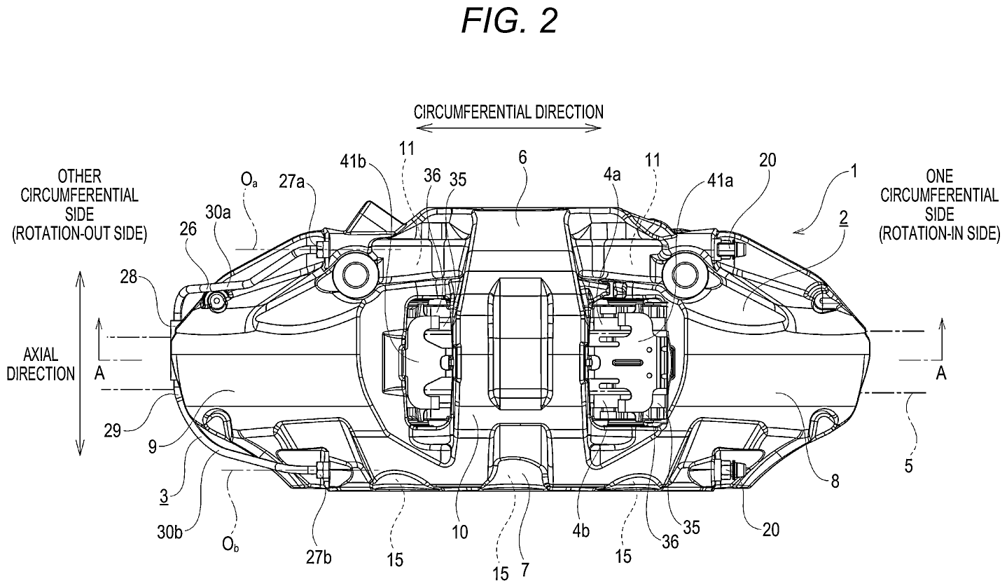

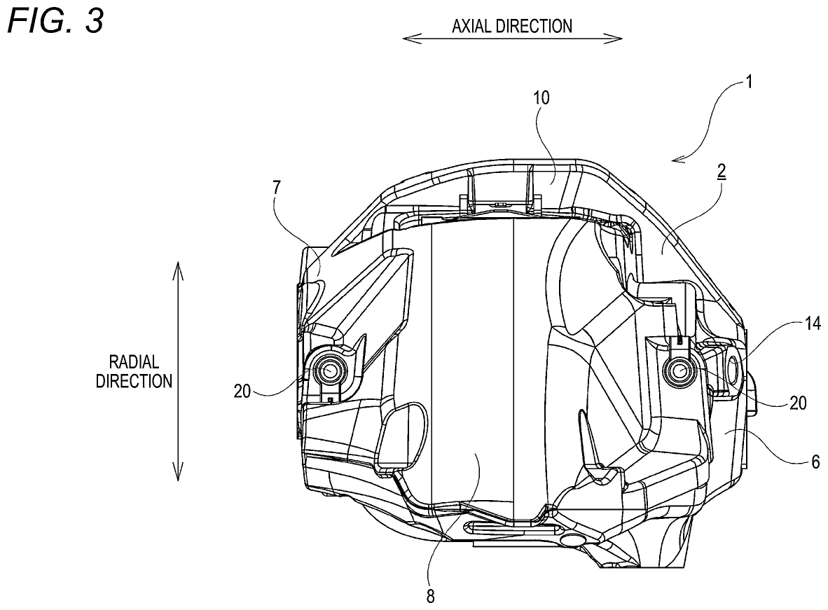

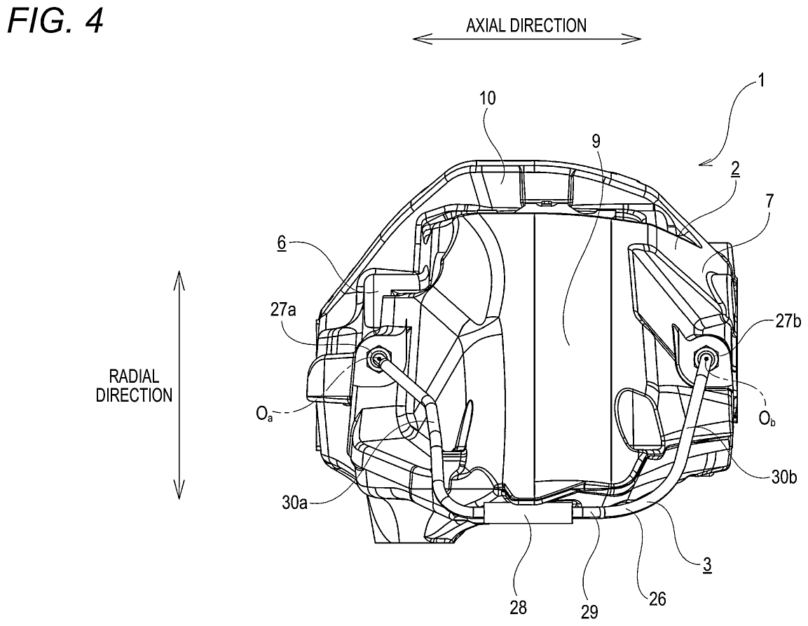

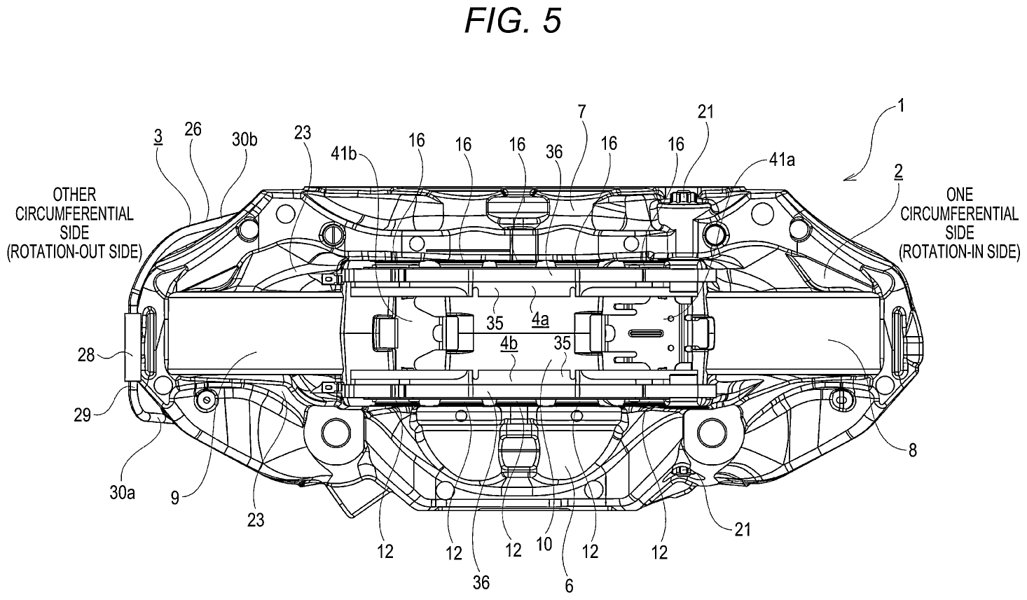

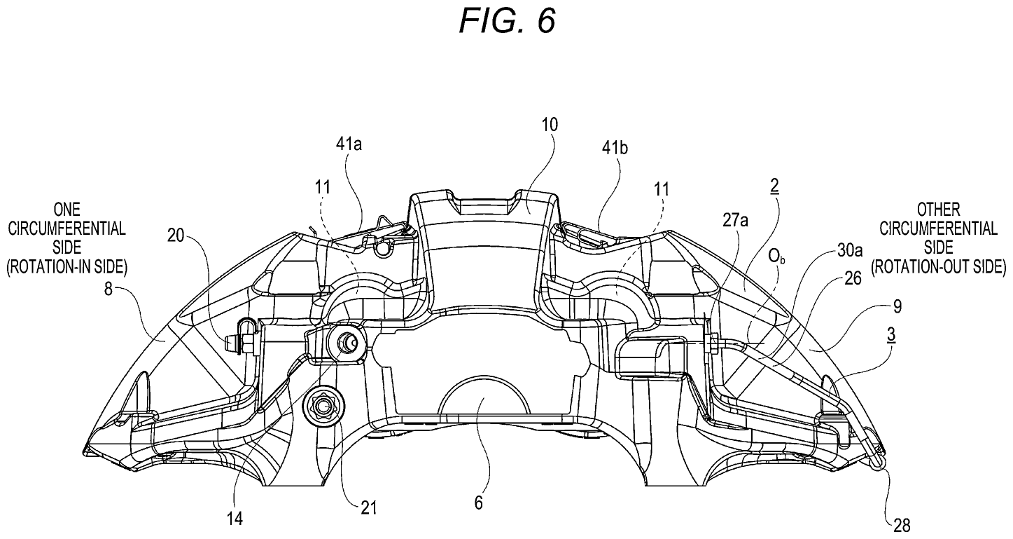

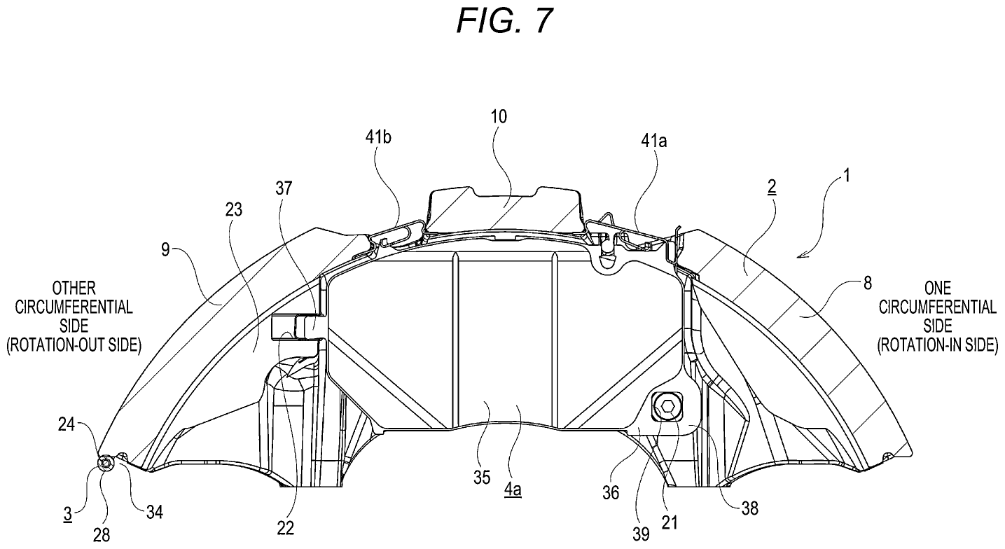

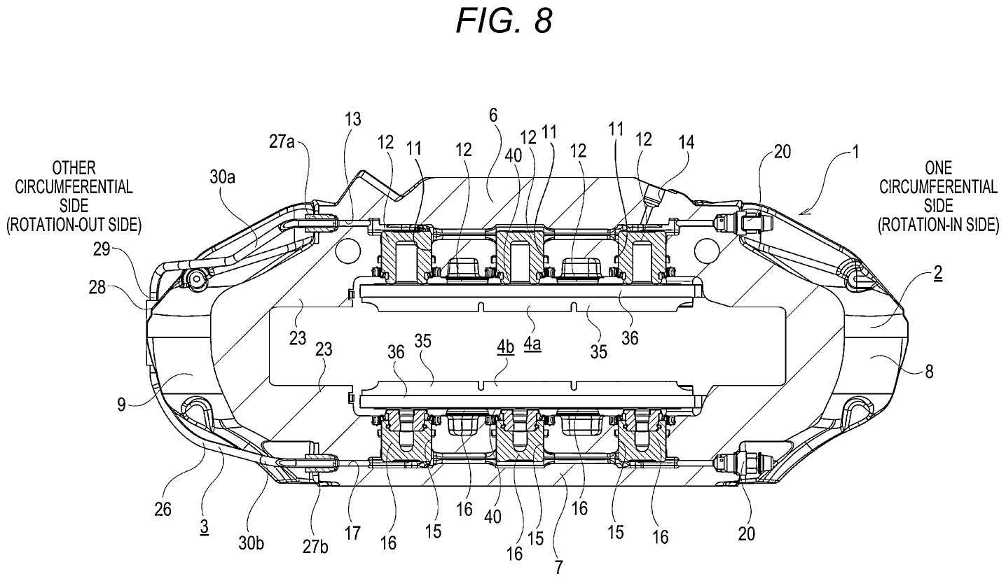

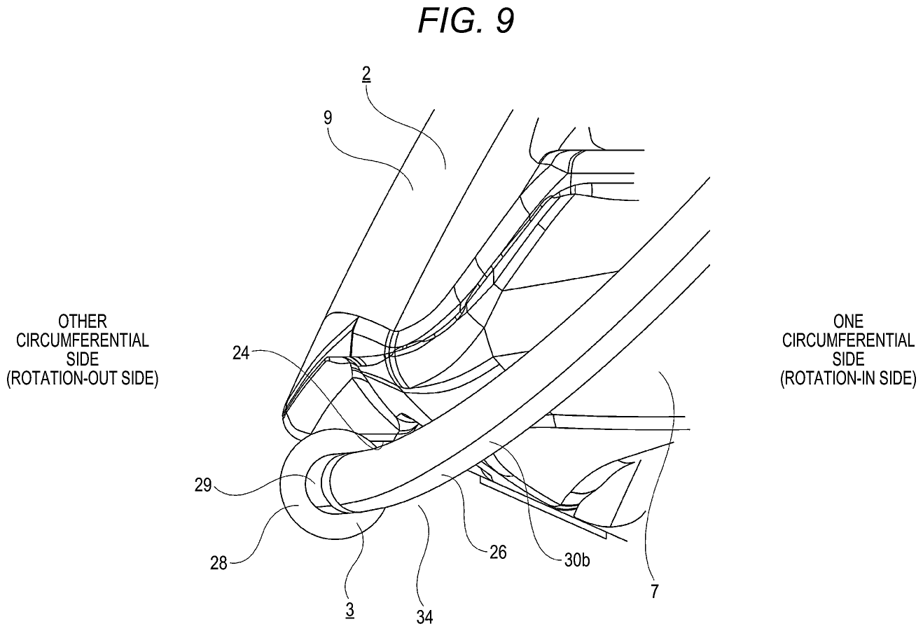

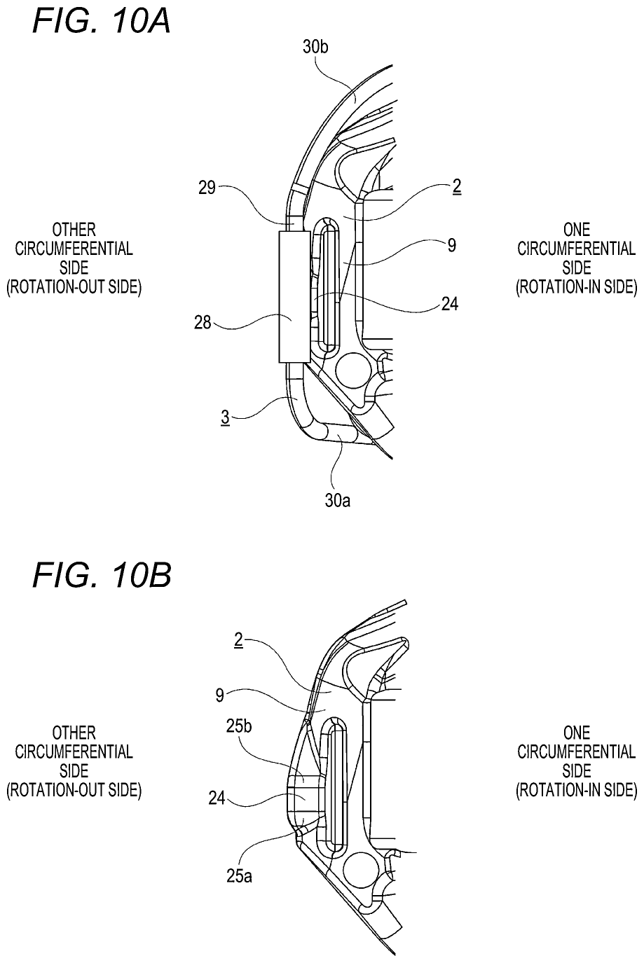

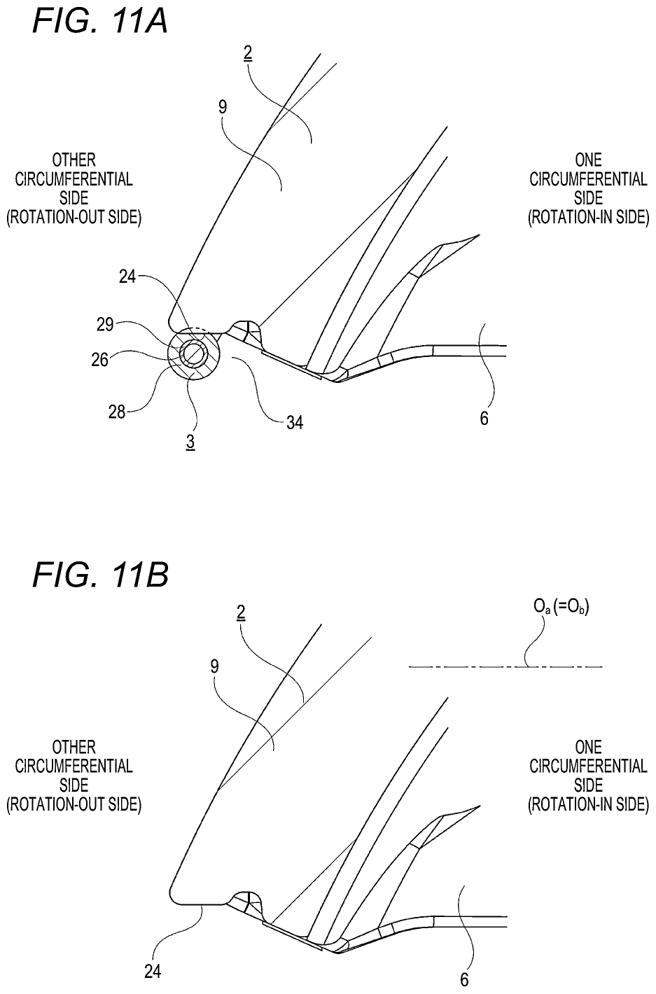

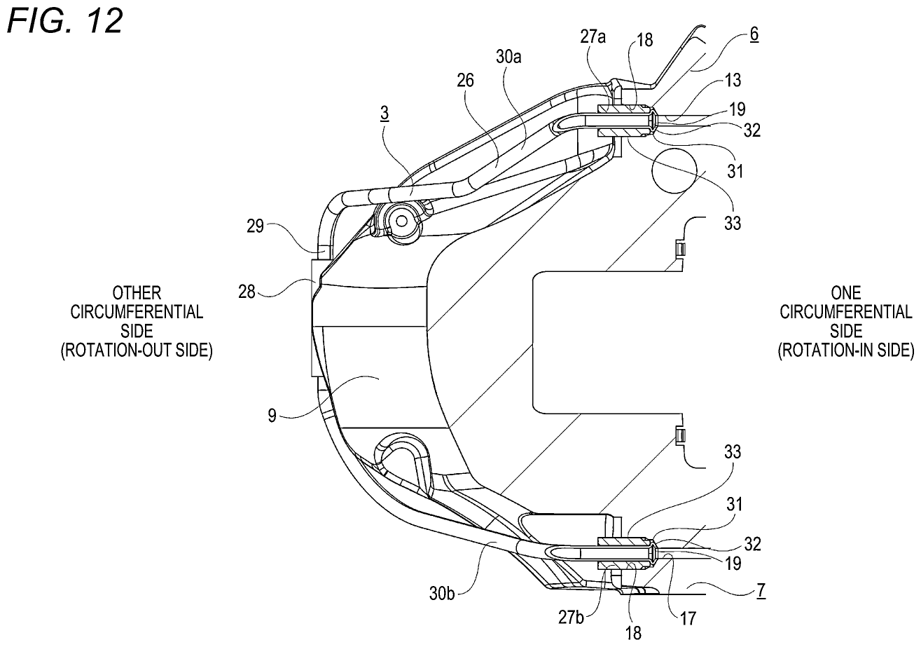

In the present specification and claims, an “axial direction”, a “circumferential direction”, and a “radial direction” refer to an axial direction, a circumferential direction, and a radial direction of a disc-shaped rotor 5 (see FIG. 2) that rotates together with a wheel, unless otherwise specified. A front-back direction in FIG. 1, FIG. 6, FIG. 7, FIG. 9, and FIGS. 11A and 11B, an upper-lower direction in FIG. 2, FIG. 5, FIG. 8, FIGS. 10A and 10B, and FIG. 12, and a left-right direction in FIG. 3 and FIG. 4 each correspond to the axial direction, a center side in a width direction of the vehicle when the opposed piston type disc brake device 1 is assembled to the vehicle is referred to as an axially inner side, and an outer side in the width direction of the vehicle when the opposed piston type disc brake device 1 is assembled to the vehicle is referred to as an axially outer side. Further, a left-right direction in FIG. 1, FIG. 2, FIG. 5 to FIG. 12, and a front-back direction in FIG. 3 and FIG. 4 each correspond to the circumferential direction, and a right side in FIG. 1, FIG. 2, FIG. 5, FIG. 7 to FIG. 12, a left side in FIG. 6, a front side in FIG. 3, and a back side in FIG. 4 are each referred to as one circumferential side, and a left side in FIG. 1, FIG. 2, FIG. 5, FIG. 7 to FIG. 12, a right side in FIG. 6, a back side in FIG. 3, and a front side in FIG. 4 are each referred to the other circumferential side. In this example, the one circumferential side corresponds to a rotation-in side when the vehicle moves forward, and the other circumferential side corresponds to a rotation-out side when the vehicle moves forward. Further, an upper-lower direction in FIG. 1, FIG. 3, FIG. 4, FIG. 6, FIG. 7, FIG. 9, and FIGS. 11A and 11B, and a front-back direction in FIG. 2, FIG. 5, FIG. 8, FIGS. 10A and 10B, and FIG. 12 each correspond to the radial direction, an upper side in FIG. 1, FIG. 3, FIG. 4, FIG. 6, FIG. 7, FIG. 9, and FIGS. 11A and 11B, a front side in FIG. 2, FIG. 8, and FIG. 12, and a back side in FIG. 5 and FIGS. 10A and 10B are each referred to as a radially outer side, a lower side in FIG. 1, FIG. 3, FIG. 4, FIG. 6, FIG. 7, FIG. 9, and FIGS. 11A and 11B, a back side in FIG. 2, FIG. 8, and FIG. 12, and a front side in FIG. 5 and FIGS. 10A and 10B are each referred to as a radially inner side.

### <Caliper>

The caliper 2 is disposed so as to cover a part of the rotor 5 in the circumferential direction from the radially outer side, and is supported and fixed to a knuckle constituting a suspension device. The caliper 2 is integrally formed by subjecting a material made of a light alloy such as an aluminum alloy or an iron-based alloy to forging or the like, and supports the pair of pads 4a and 4b in a manner of being movable in the axial direction. The caliper 2 has a boat shape as a whole, and a substantially bow shape as viewed in the axial direction as shown in FIGS. 1 and 6.

The caliper 2 includes an inner body 6, an outer body 7, a rotation-in-side coupling portion 8, a rotation-out-side coupling portion 9, and an intermediate coupling portion 10.

The inner body 6 and the outer body 7 are disposed on both axial sides of the rotor 5 in a manner of sandwiching the rotor 5.

The inner body 6 is disposed axially inward of the rotor 5. The inner body 6 includes a plurality of (five in the illustrated example) inner cylinders 11. An inner piston 12 is fitted to each of the inner cylinders 11 in a manner of being displaceable in the axial direction.

As shown in FIG. 8, the inner body 6 has an inner oil passage hole 13 for supplying brake oil to and discharging the brake oil from a deep portion of the inner cylinder 11. The inner oil passage hole 13 extends in the circumferential direction and communicates with the deep portion of each of the plurality of inner cylinders 11.

The inner body 6 has a connection port 14 for connecting a brake hose (not shown). The connection port 14 communicates with the inner oil passage hole 13.

The outer body 7 is disposed axially outward of the rotor 5. The outer body 7 includes a plurality of (five in the illustrated example) outer cylinders 15. An outer piston 16 is fitted to each of the outer cylinders 15 in a manner of being displaceable in the axial direction.

As shown in FIG. 8, the outer body 7 has an outer oil passage hole 17 for supplying the brake oil to and discharging the brake oil from a deep portion of the outer cylinder 15. The outer oil passage hole 17 extends in the circumferential direction and communicates with the deep portion of each of the plurality of outer cylinders 15.

End portions on the other circumferential side of the inner oil passage hole 13 and the outer oil passage hole 17 respectively open toward the other circumferential side at the other circumferential side portions of the inner body 6 and the outer body 7.

The end portions on the other circumferential side of the inner oil passage hole 13 and the outer oil passage hole 17 are connected to each other by the communication pipe 3. Accordingly, the inner oil passage hole 13 and the outer oil passage hole 17 communicate with each other.

As shown in FIG. 12, each of the end portions on the other circumferential side of the inner oil passage hole 13 and the outer oil passage hole 17 is provided with a female screw portion 18. Flare nuts 27a and 27b, which will be described later, constituting the communication pipe 3 are screwed and connected to the female screw portions 18. The female screw portion 18 provided in the inner oil passage hole 13 and the female screw portion 18 provided in the outer oil passage hole 17 are arranged parallel to each other.

A pressed surface 19 having a conical concave surface shape is provided in a portion on a deep side (one circumferential side) of the female screw portion 18 in the end portion on the other circumferential side of each of the inner oil passage hole 13 and the outer oil passage hole 17. A sealing surface 32 provided in an end portion of a pipe body 26, which will be described later, constituting the communication pipe 3 is pressed against the pressed surface 19.

End portions on the one circumferential side of the inner oil passage hole 13 and the outer oil passage hole 17 respectively open toward the one circumferential side at one circumferential side portions of the inner body 6 and the outer body 7.

The end portions on the one circumferential side of the inner oil passage hole 13 and the outer oil passage hole 17 are closed by bleeder screws 20.

As shown in FIG. 7, each of the inner body 6 and the outer body 7 includes a pin 21 and a guide recessed groove 22 in order to support the pads 4a and 4b movably in the axial direction.

The pin 21 is provided on a radially inner portion of the one circumferential side portion of each of the inner body 6 and the outer body 7, and is arranged parallel to a central axis of the rotor 5. The pin 21 is supported and fixed to each of the inner body 6 and outer body 7. The pair of pins 21 respectively supported and fixed to the inner body 6 and the outer body 7 are disposed coaxially with each other. Regarding the pair of pins 21, a tip of one pin 21 supported and fixed to the inner body 6 protrudes axially outward from an axially outer surface of the inner body 6, and faces an axially inner surface of the rotor 5 via a gap therebetween. In contrast, a tip of the other pin 21 supported and fixed to the outer body 7 protrudes axially inward from an axially inner surface of the outer body 7, and faces an axially outer surface of the rotor 5 with a gap therebetween. The tip of each of the pair of pins 21 is formed in a substantially cylindrical shape, and has a cylindrical outer peripheral surface shape.

The guide recessed groove 22 is provided in a guide wall portion 23 provided so as to protrude in the axial direction on an axially inner portion of the other circumferential side portion of each of the inner body 6 and the outer body 7. The guide recessed groove 22 is provided in a radially intermediate portion of the guide wall portion 23, and is opened in each of an axial side surface (side surface on a rotor 5 side) and a side surface on the one circumferential side of the guide wall portion 23.

Each of the rotation-in-side coupling portion 8 and the rotation-out-side coupling portion 9 is disposed on a radially outer side of the rotor 5, and couples circumferential end portions of the inner body 6 and the outer body 7 to each other in the axial direction. Each of the rotation-in-side coupling portion 8 and the rotation-out-side coupling portion 9 is curved in an arc shape along an outer peripheral edge of the rotor 5, and covers the rotor 5 from the radially outer side via a predetermined gap.

The rotation-in-side coupling portion 8 couples end portions on the one circumferential side of the inner body 6 and the outer body 7 in the axial direction.

The rotation-out-side coupling portion 9 couples end portions on the other circumferential side of the inner body 6 and the outer body 7 in the axial direction.

As shown in FIG. 10B and FIG. 11B, the rotation-out-side coupling portion 9 includes a contact surface 24 at an axially intermediate portion of an end portion on the other circumferential side. The contact surface 24 is provided on an end surface on the other circumferential side of the rotation-out-side coupling portion 9, is planar, and faces the radially inner side. The contact surface 24 is disposed radially inward of the female screw portion 18 provided in each of the inner body 6 and the outer body 7. Further, the contact surface 24 is arranged substantially parallel to a central axis of the female screw portion 18 provided in each of the inner body 6 and the outer body 7, and central axes Oa and Ob of the flare nuts 27a and 27b (to be described later) constituting the communication pipe 3. In this example, the contact surface 24 has a substantially square shape in which an axial width and a circumferential width are substantially the same.

The rotation-out-side coupling portion 9 includes a pair of inclined surfaces 25a and 25b on both axial sides of the contact surface 24, which extend radially outward as a distance from the contact surface 24 increases in the axial direction.

The intermediate coupling portion 10 is disposed on the radially outer side of the rotor 5, and couples circumferential intermediate portions of the inner body 6 and the outer body 7 in the axial direction. The intermediate coupling portion 10, the rotation-in-side coupling portion 8, and the rotation-out-side coupling portion 9 are separated from one another in the circumferential direction.

### <Communication Pipe>

The communication pipe 3 is disposed around the caliper 2 so as to cover the other circumferential side portion of the caliper 2 from the other circumferential side.

The communication pipe 3 includes the pipe body 26, the pair of flare nuts 27a and 27b, and a cover tube 28.

The pipe body 26 is made of metal and has a substantially U-shape as viewed in the radial direction.

The pipe body 26 includes an axially extending portion 29 extending substantially linearly in the axial direction in a manner of straddling the rotor 5, and a pair of circumferentially extending portions 30a and 30b extending from end portions on both axial sides of the axially extending portion 29 toward the one circumferential side and the radially outer side.

In a state in which the communication pipe 3 is connected to the caliper 2, the axially extending portion 29 is disposed on a radially inner side of the end portion on the other circumferential side of the rotation-out-side coupling portion 9.

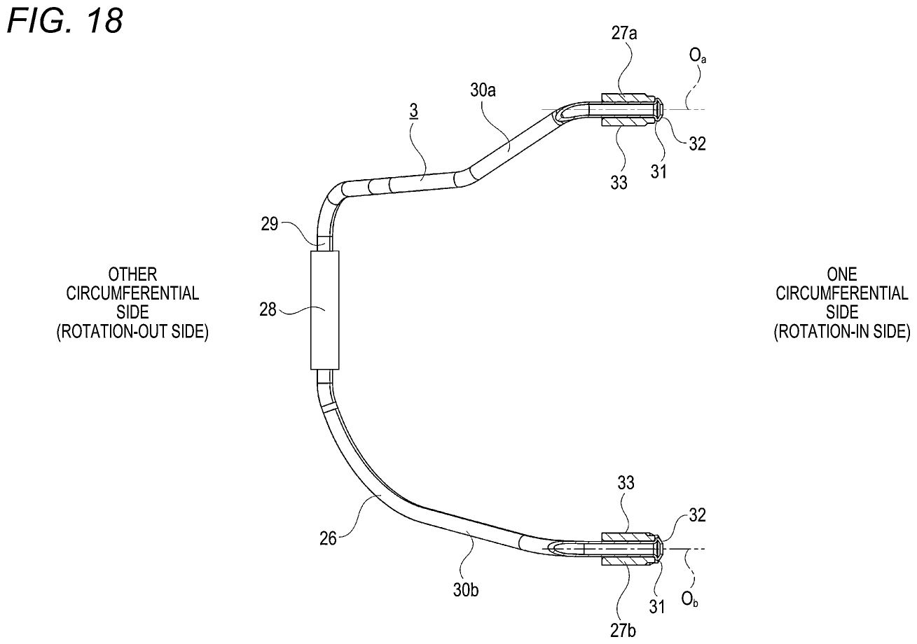

As shown in FIG. 18, the pipe body 26 includes bent portions 31 having an outer diameter larger than that of other portions at end portions on both sides thereof. That is, each of the pair of circumferentially extending portions 30a and 30b constituting the pipe body 26 includes the bent portion 31 at the end portion thereof on the one circumferential side. The bent portion 31 has a substantially V-shaped cross-sectional shape, and includes the sealing surface 32 having a conical convex surface shape facing the one circumferential side. The bent portion 31 functions to suppress the flare nuts 27a and 27b from coming off.

The pair of flare nuts 27a and 27b has a substantially cylindrical shape, and are provided on the end portions on the both sides of the pipe body 26 in a manner of being rotatable relative to the pipe body 26 in a state in which the respective central axes Oa and Ob are arranged substantially parallel to each other. Specifically, the flare nuts 27a and 27b are loosely fitted to portions of the circumferentially extending portions 30a and 30b that are deviated from the bent portions 31 toward the other circumferential side in a manner of being rotatable relative to the circumferentially extending portions 30a and 30b.

Each of the flare nuts 27a and 27b includes a male screw portion 33 on an outer peripheral surface thereof. The flare nuts 27a and 27b have an outer diameter larger than that of the bent portion 31.

Regarding the flare nuts 27a and 27b, the one flare nut 27a is loosely fitted to the end portion on the one circumferential side of the circumferentially extending portion 30a disposed axially inward of the rotor 5, and is screwed and connected to the other circumferential side portion of the inner body 6.

Specifically, as shown in FIG. 12, the flare nut 27a is screwed and connected to the other circumferential side portion of the inner body 6 by screwing the male screw portion 33 provided on the outer peripheral surface thereof to the female screw portion 18 provided in the inner oil passage hole 13.

When the male screw portion 33 is screwed into the female screw portion 18, the flare nut 27a presses the bent portion 31 provided on the circumferentially extending portion 30a toward the one circumferential side, thereby pressing the sealing surface 32 of the bent portion 31 against the pressed surface 19 provided on the inner oil passage hole 13. Accordingly, the sealing surface 32 and the pressed surface 19 are brought into close contact (surface contact) with each other to ensure sealing performance of a connection portion between the communication pipe 3 and the inner body 6.

Regarding the flare nuts 27a and 27b, the other flare nut 27b is loosely fitted to the end portion on the one circumferential side of the circumferentially extending portion 30b disposed axially outward of the rotor 5, and is screwed and connected to the other circumferential side portion of the outer body 7.

Specifically, the flare nut 27b is screwed and connected to the other circumferential side portion of the outer body 7 by screwing the male screw portion 33 provided on the outer peripheral surface thereof into the female screw portion 18 provided in the outer oil passage hole 17.

When the male screw portion 33 is screwed into the female screw portion 18, the flare nut 27b presses the bent portion 31 provided on the circumferentially extending portion 30b toward the one circumferential side, thereby pressing the sealing surface 32 of the bent portion 31 against the pressed surface 19 provided on the outer oil passage hole 17. Accordingly, the sealing surface 32 and the pressed surface 19 are brought into close contact with each other to ensure sealing performance of a connection portion between the communication pipe 3 and the outer body 7.

In the case of the opposed piston type disc brake device 1 according to this example, the respective central axes Oa and Ob of the pair of flare nuts 27a and 27b extend along the circumferential direction. Therefore, central axis directions of the flare nuts 27a and 27b substantially coincide with the circumferential direction.

The cover tube 28 is made of an elastic material such as rubber and has a cylindrical shape in a free state. The cover tube 28 covers an axially intermediate portion of the axially extending portion 29 constituting the pipe body 26. Accordingly, the cover tube 28 is disposed on the radially inner side of the end portion on the other circumferential side of the rotation-out-side coupling portion 9 constituting the caliper 2. Further, a central axis of the cover tube 28 is arranged substantially parallel to the central axis of the rotor 5.

The cover tube 28 is in contact with the caliper 2 with a fastening margin in a state in which the one flare nut 27a is screwed and connected to the inner body 6 and the other flare nut 27b is screwed and connected to the outer body 7.

However, in this example, the cover tube 28 does not have fastening margins with respect to the caliper 2 in the central axis directions (circumferential direction) of the flare nuts 27a and 27b.

In this example, the cover tube 28 is pressed against the caliper 2 only in one predetermined direction other than the central axis directions of the flare nuts 27a and 27b. That is, the cover tube 28 is pressed against the caliper 2 only in the one direction, and a pressing direction of the cover tube 28 against the caliper 2 does not coincide with the central axis directions of the flare nuts 27a and 27b.

Specifically, the cover tube 28 is in contact with only the contact surface 24 of the caliper 2 which is provided on the rotation-out-side coupling portion 9 and which faces the radially inner side, and is pressed against the contact surface 24 on the radially outer side (upper side in FIG. 9 and FIG. 11A and back side in FIG. 10A) substantially perpendicular to the central axis directions of the flare nuts 27a and 27b. Therefore, the cover tube 28 is pressed against the caliper 2 only radially outward, and is in contact with the caliper 2 only with a radial fastening margin. Therefore, the cover tube 28 does not have the fastening margins with respect to the caliper 2 in the circumferential direction that substantially coincides with the central axis directions of the flare nuts 27a and 27b. A gap 34 is provided between the cover tube 28 and the caliper 2 in the central axis directions of the flare nuts 27a and 27b.

In this example, since the cover tube 28 is in contact with only the contact surface 24 of the caliper 2, gaps are provided between a radially outer portion of an outer peripheral surface of the cover tube 28 and the inclined surfaces 25a and 25b provided on both the axial sides of the contact surface 24. Therefore, in the cover tube 28, only the radially outer portion of the axially intermediate portion in contact with the contact surface 24 is elastically deformed.

In this example, since the cover tube 28 is pressed against the caliper 2 only radially outward, only movement of the cover tube 28 to the radially outer side is limited by the caliper 2 during a connection work of the communication pipe 3 to the caliper 2. In other words, the movement of the cover tube 28 in a direction other than the radially outer side can be performed without being limited by the caliper 2.

In this example, an axial dimension of the cover tube 28 is larger than the axial width of the contact surface 24. In the illustrated example, the axial dimension of the cover tube 28 is about five times the axial width of the contact surface 24. Further, an outer diameter of the cover tube 28 is larger than the circumferential width of the contact surface 24.

An end portion on the other circumferential side of the cover tube 28 is disposed at substantially the same circumferential position as the end portion on the other circumferential side of the rotation-out-side coupling portion 9. However, the end portion on the other circumferential side of the cover tube 28 can be disposed on the other circumferential side, or on the one circumferential side, with respect to the end portion on the other circumferential side of the rotation-out-side coupling portion 9.

When the communication pipe 3 is connected to the caliper 2, first, the flare nuts 27a and 27b are inserted into the end portions on the other circumferential side of the inner oil passage hole 13 and the outer oil passage hole 17, respectively, in a state in which an end portion on the radially outer side of the cover tube 28 is brought into contact with the contact surface 24, and the flare nuts 27a and 27b are rotated around the central axes Oa and Ob. Accordingly, the male screw portions 33 provided on the outer peripheral surfaces of the flare nuts 27a and 27b are respectively screwed into the female screw portions 18 provided in the inner oil passage hole 13 and the outer oil passage hole 17, and the entire communication pipe 3 is moved to the one circumferential side, which is a proximal side to the caliper 2, in the circumferential direction substantially coinciding with the central axis directions of the flare nuts 27a and 27b. Further, the sealing surfaces 32 provided on the end portions on the both sides of the pipe body 26 are pressed against the pressed surfaces 19 provided in the inner oil passage hole 13 and the outer oil passage hole 17, respectively.

### <Pad>

Each of the pair of pads 4a and 4b includes a lining 35 and a metal pressure plate 36 supporting a back surface of the lining 35.

The pressure plate 36 includes, at a radially intermediate portion of an end portion on the other circumferential side, an ear portion 37 protruding toward the other circumferential side with respect to the lining 35.

The ear portion 37 is formed in a substantially rectangular plate shape, and is engaged with the guide recessed groove 22 provided in each of the inner body 6 and the outer body 7 in a manner of being movable in the axial direction.

The pressure plate 36 includes, at a radially inner portion of an end portion on the one circumferential side, a protruding plate portion 38 having a substantially triangular plate shape protruding in the circumferential direction from the lining 35. An insertion hole 39 penetrating in the axial direction is formed in the protruding plate portion 38. The insertion hole 39 is formed in a substantially rectangular shape as viewed in the axial direction, and opens only at both axial sides of the protruding plate portion 38. The pin 21 provided in each of the inner body 6 and the outer body 7 is loosely inserted into the insertion hole 39. Accordingly, the insertion hole 39 is engaged with the pin 21 so as to be movable in the axial direction.

As described above, the pads 4a and 4b are respectively supported movably in the axial direction with respect to the inner body 6 and the outer body 7 by engaging the ear portion 37 with the guide recessed groove 22 in a manner of being movable in the axial direction and engaging the pin 21 with the insertion hole 39 in a manner of being movable in the axial direction. Regarding a support structure of each of a pair of pads for a caliper, various known structures in the related art can also be adopted.

A shim plate 40 made of a metal plate such as a stainless steel plate is attached to a back side of the pressure plate 36 so as to cover a back surface of the pressure plate 36.

The opposed piston type disc brake device 1 in this example further includes a pair of pad springs 41a and 41b. The pad springs 41a and 41b press the pads 4a and 4b radially inward to suppress rattling of the pads 4a and 4b during non-braking.

During braking performed by the opposed piston type disc brake device 1 in this example, the brake oil is fed from a master cylinder to the inner oil passage hole 13 via the brake hose (not shown) connected to the connection port 14 of the inner body 6. Accordingly, the inner piston 12 is pushed out from the inner cylinder 11 in the axial direction, and the pad 4a supported by the inner body 6 is pressed against the axially inner surface of the rotor 5. Further, the brake oil is fed from the inner oil passage hole 13 to the outer oil passage hole 17 through the communication pipe 3. Accordingly, the outer piston 16 is pushed out from the outer cylinder 15 in the axial direction, and the pad 4b supported by the outer body 7 is pressed against an axially outer surface of the rotor 5. As a result, the rotor 5 is strongly sandwiched by the pair of pads 4a and 4b from both the axial sides, and the braking of the vehicle is performed.

According to the opposed piston type disc brake device 1 in this example as described above, it is possible to improve efficiency of an assembly work compared to the structure in the related art while suppressing the communication pipe 3 from floating with respect to the caliper 2, and it is possible to suppress an excessive tensile stress from being applied to a connection portion between the communication pipe 3 and the caliper 2.

That is, in the case of this example, the cover tube 28 made of the elastic material is brought into contact with the caliper 2 with the fastening margin, and thus it is possible to suppress the communication pipe 3 from floating from the caliper 2, and it is possible to suppress the gap from being formed between the cover tube 28 and the caliper 2. Accordingly, a portion of a surface of the caliper 2 which is covered with the cover tube 28 and is not coated is suppressed from being exposed, and the communication pipe 3 is suppressed from interfering with a wheel disposed around the opposed piston type disc brake device 1.

In particular, in this example, the cover tube 28 has no fastening margin in the central axis directions of the flare nuts 27a and 27b. In this example, the cover tube 28 is not pressed against the caliper 2 in the central axis directions of the flare nuts 27a and 27b, but is pressed against the contact surface 24 of the caliper 2 only on the radially outer side substantially perpendicular to the central axis directions of the flare nuts 27a and 27b. Accordingly, the cover tube 28 has only the radial fastening margin, and does not have the fastening margin in the central axis directions (circumferential direction) of the flare nuts 27a and 27b.

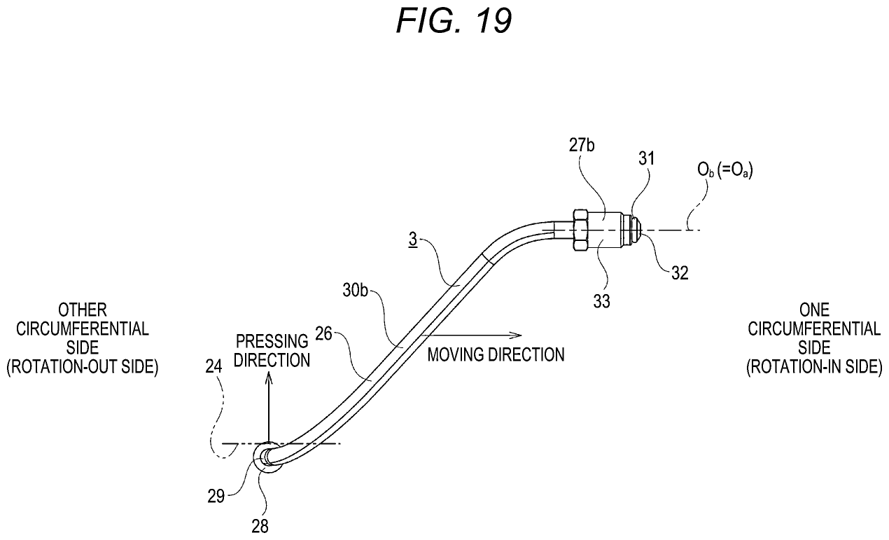

Therefore, as shown in FIG. 19, when the entire communication pipe 3 is moved to the one circumferential side in order to respectively screw and connect the flare nuts 27a and 27b to the inner body 6 and the outer body 7, it is not necessary to increase an elastic deformation amount of the cover tube 28 with respect to the contact surface 24. Accordingly, it is not necessary to increase tightening torque when the flare nuts 27a and 27b are screwed and connected. As a result, according to the opposed piston type disc brake device 1 in this example, the efficiency of the assembly work can be improved compared to the structure in the related art.

In this example, since the contact surface 24 is arranged substantially parallel to the central axes Oa and Ob of the flare nuts 27a and 27b, the elastic deformation amount of the cover tube 28 with respect to the contact surface 24 when the communication pipe 3 is moved to the one circumferential side can be constant. Therefore, the tightening torque of the flare nuts 27a and 27b can be effectively suppressed from increasing.

In this example, during the connection work of the communication pipe 3, the cover tube 28 can be moved in any direction other than the radially outer side without being limited by the caliper 2. Therefore, even when there is a dimensional variation or the like in the pipe body 26, the variation can be absorbed by moving the cover tube 28. Therefore, from this point of view, it is also possible to improve the efficiency of the assembly work of the opposed piston type disc brake device 1.

In this example, since the cover tube 28 has only the radial fastening margin and does not have the fastening margin in the central axis directions of the flare nuts 27a and 27b, the tensile stress applied to the connection portion between the communication pipe 3 and the caliper 2 can be reduced as compared with the structure in the related art. Therefore, it is possible to suppress the sealing surface 32 provided on the end portion of the pipe body 26 from being separated from the pressed surface 19 and to suppress a gap from being formed between the sealing surface 32 and the pressed surface 19. Accordingly, sealing performance of the connection portion between the communication pipe 3 and the caliper 2 can be secured. As a result, according to the opposed piston type disc brake device 1 in this example, a defective fraction can be reduced. Further, even when a fastening margin of the cover tube 28 with respect to the contact surface 24 is increased, there is no influence on the tensile stress applied to the connection portion between the communication pipe 3 and the caliper 2, and thus by increasing the fastening margin, the effect of suppressing the communication pipe 3 from floating can be enhanced.

In this example, since the cover tube 28 is pressed toward the radially outer side with respect to the contact surface 24 provided in the rotation-out-side coupling portion 9, the rotation-out-side coupling portion 9 can suppress the axially extending portion 29 from floating toward the radially outer side due to a vibration or the like applied when the vehicle is traveling, and the interference between the communication pipe 3 and the wheel can be effectively suppressed.

In this example, only the axially intermediate portion of the cover tube 28 is in contact with the contact surface 24, and the entire cover tube 28 in the axial direction is not in contact with the contact surface 24. Therefore, it is possible to reduce a range of the pipe body 26 in which movement with respect to the caliper 2 is limited by the contact with the caliper 2, and it is possible to easily deform the pipe body 26. Therefore, even in the case in which there is the dimensional variation or the like in the pipe body 26, it is possible to suppress workability of the connection work of the communication pipe 3 from being lowered.

### Second Embodiment

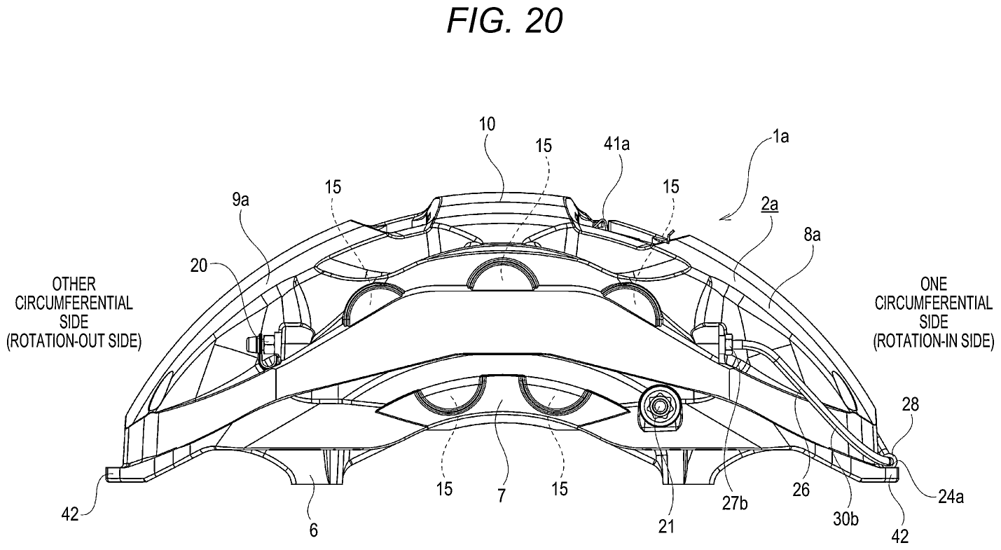

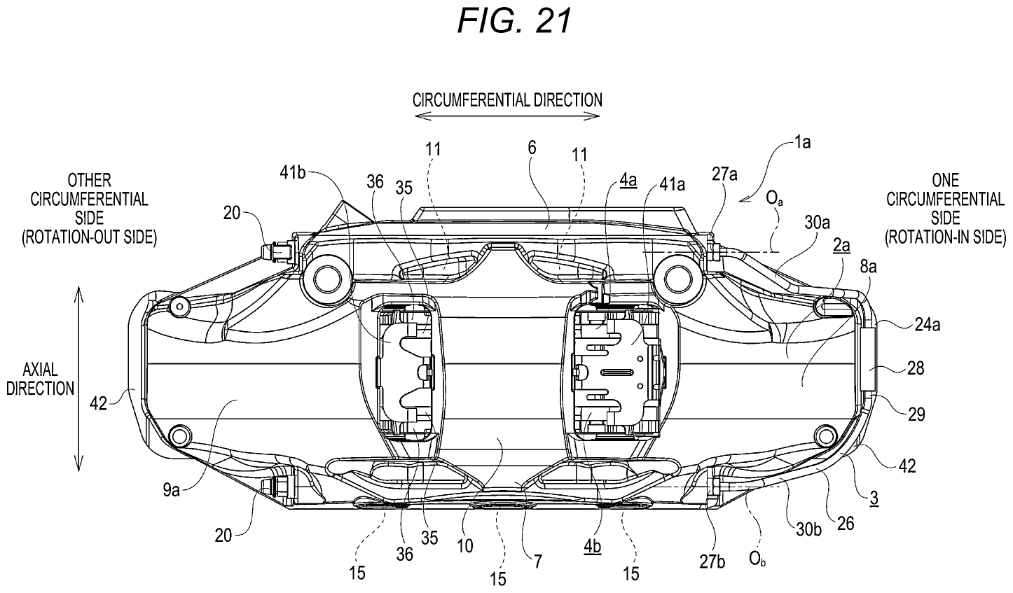

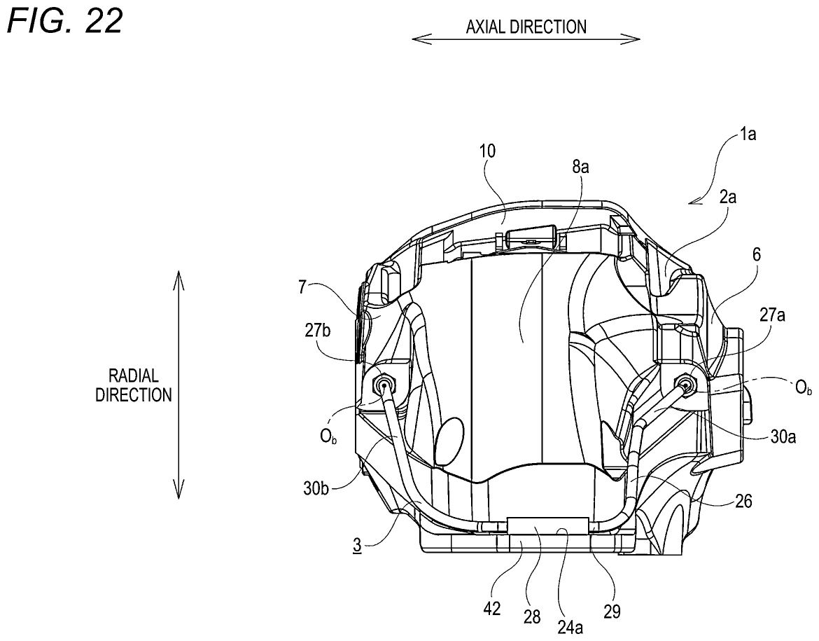

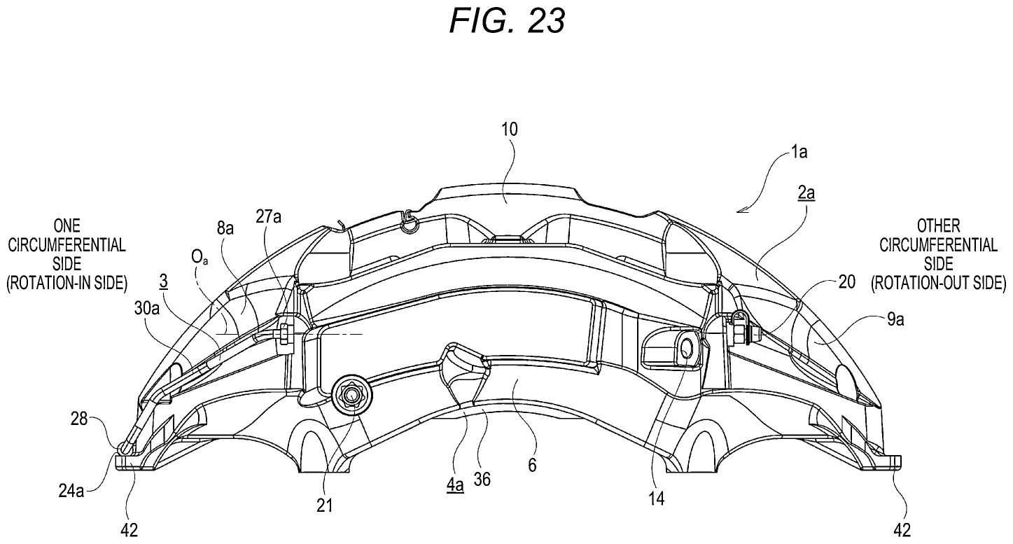

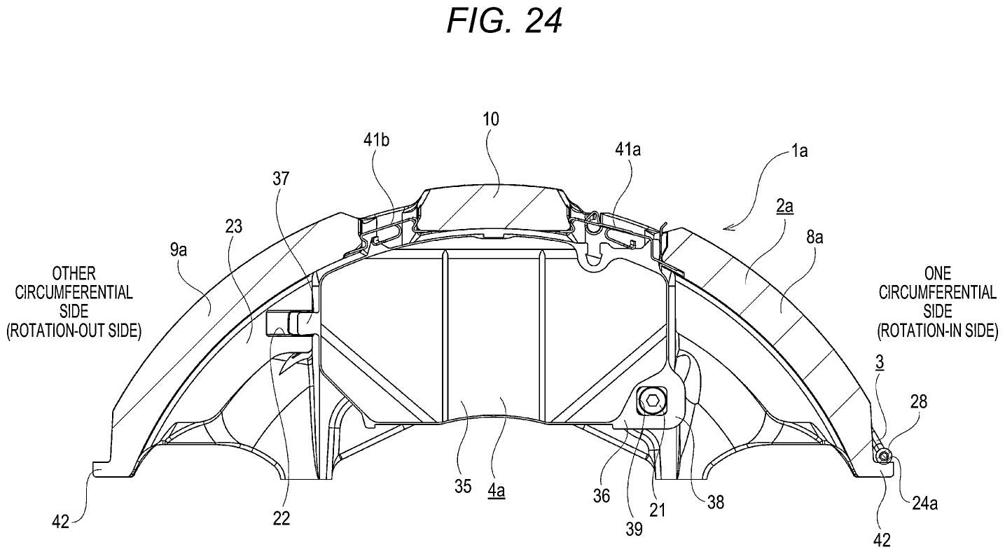

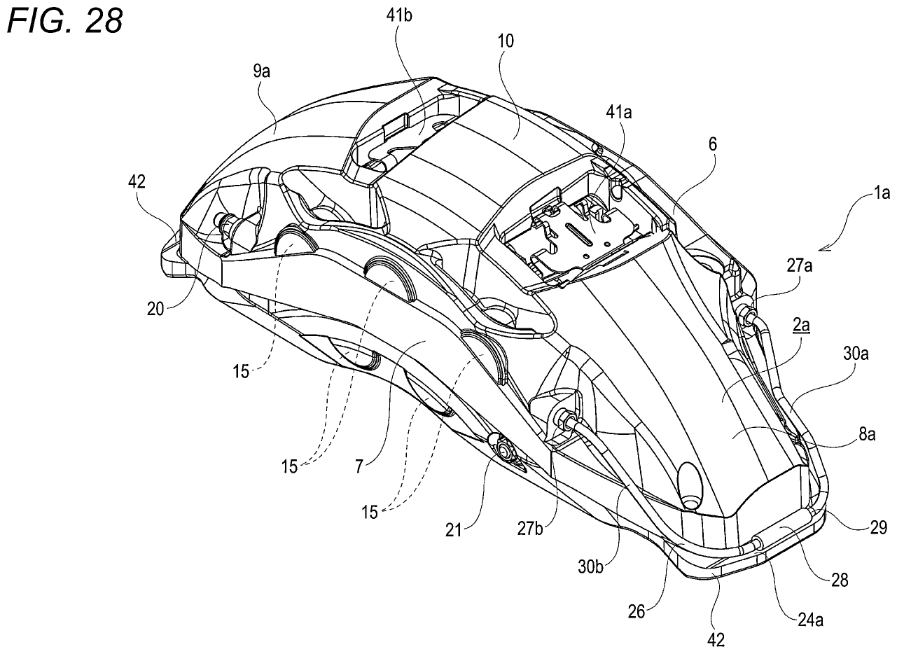

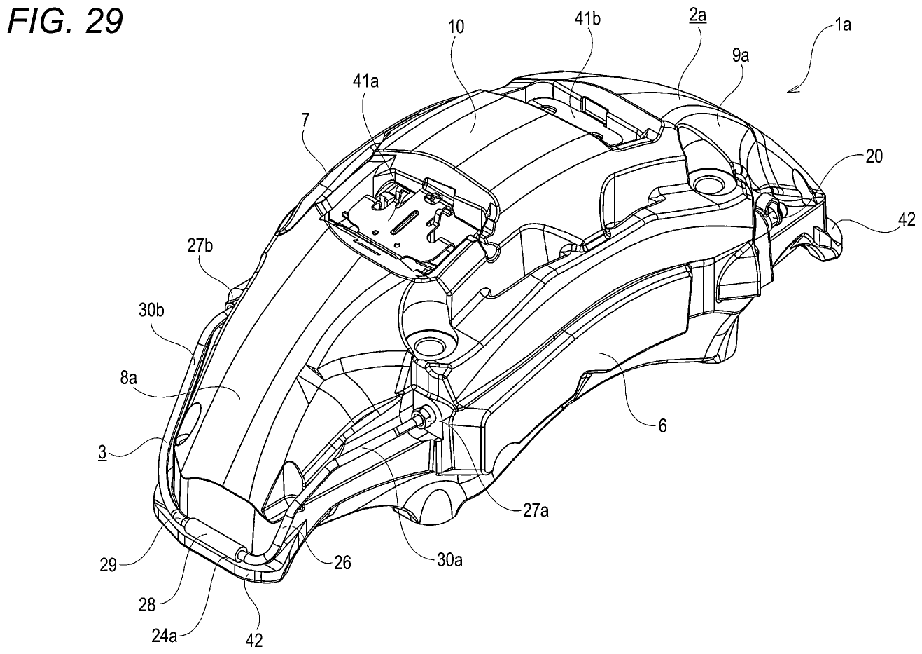

A second embodiment will be described with reference to FIGS. 20 to 31.

In an opposed piston type disc brake device 1a according to this example, a contact mode of the cover tube 28 with respect to a caliper 2a is different from that of the first embodiment.

The caliper 2a of this example includes a protruding portion 42 protruding in the circumferential direction on an end portion on a radially inner side of an end portion on one circumferential side of a rotation-in-side coupling portion 8a. In the illustrated example, the caliper 2a includes the protruding portion 42 not only on the rotation-in-side coupling portion 8a but also on the rotation-out-side coupling portion 9a.

The protruding portion 42 includes a contact surface 24a on a radially outer surface thereof. The contact surface 24a has a planar shape and faces radially outward. The contact surface 24a is arranged substantially parallel to the central axes Oa and Ob of the flare nuts 27a and 27b constituting the communication pipe 3.

The contact surface 24a has a substantially rectangular shape having an axial width larger than a circumferential width.

In the opposed piston type disc brake device 1a of this example, the communication pipe 3 connects end portions on the one circumferential side of the inner oil passage hole 13 provided in the inner body 6 and the outer oil passage hole 17 provided in the outer body 7. End portions on the other circumferential side of the inner oil passage hole 13 and the outer oil passage hole 17 are closed by the bleeder screws 20.

The communication pipe 3 is disposed around the caliper 2a so as to cover one circumferential side portion of the caliper 2a from the one circumferential side.

Similarly, in the case of this example, the cover tube 28 constituting the communication pipe 3 has no fastening margin in the central axis directions (circumferential direction) of the flare nuts 27a and 27b with respect to the caliper 2a in a state in which one flare nut 27a is screwed and connected to the inner body 6 and the other flare nut 27b is screwed and connected to the outer body 7. The cover tube 28 is pressed against the caliper 2a only in one predetermined direction other than the central axis directions of the flare nuts 27a and 27b.

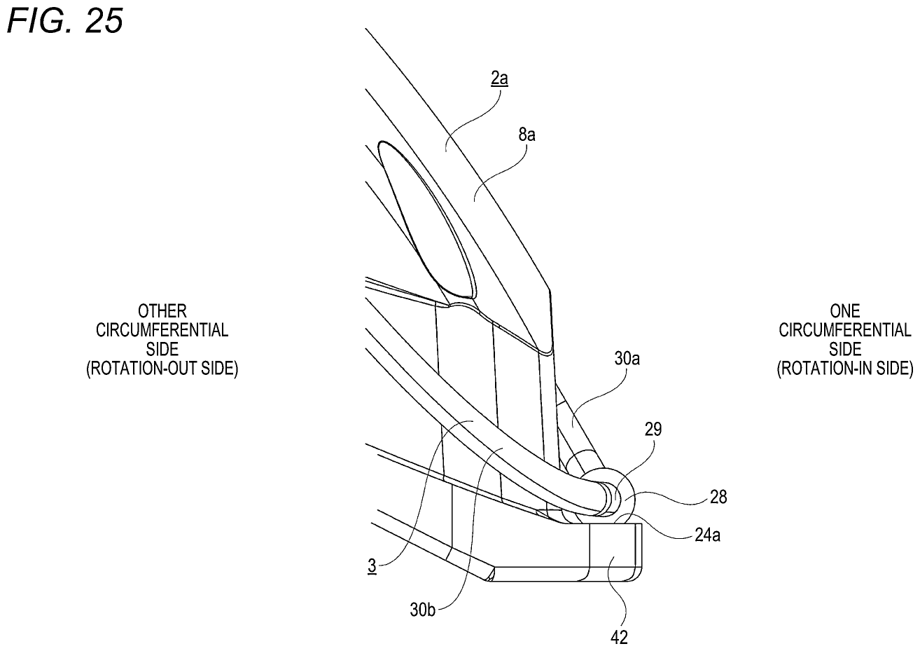

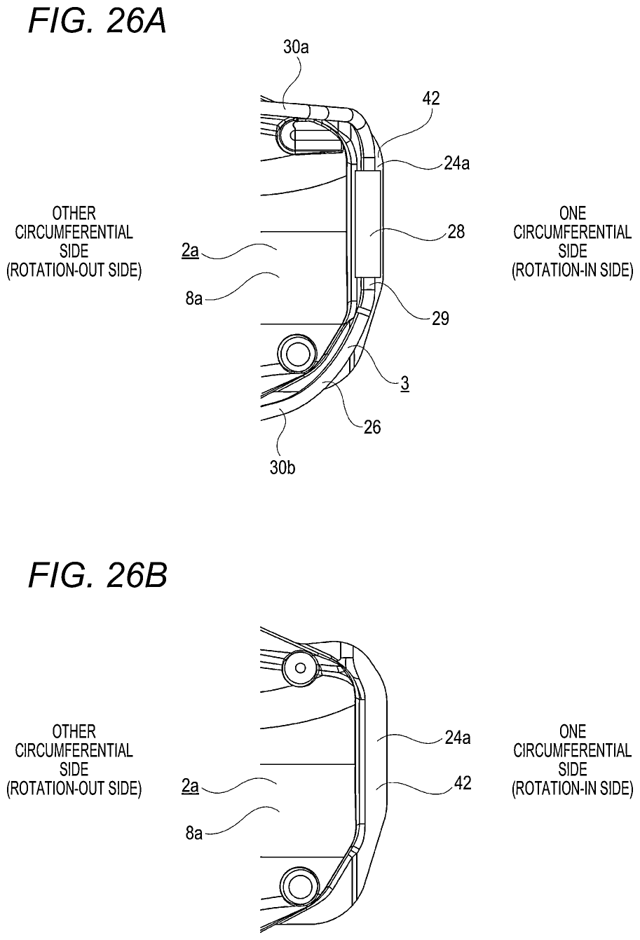

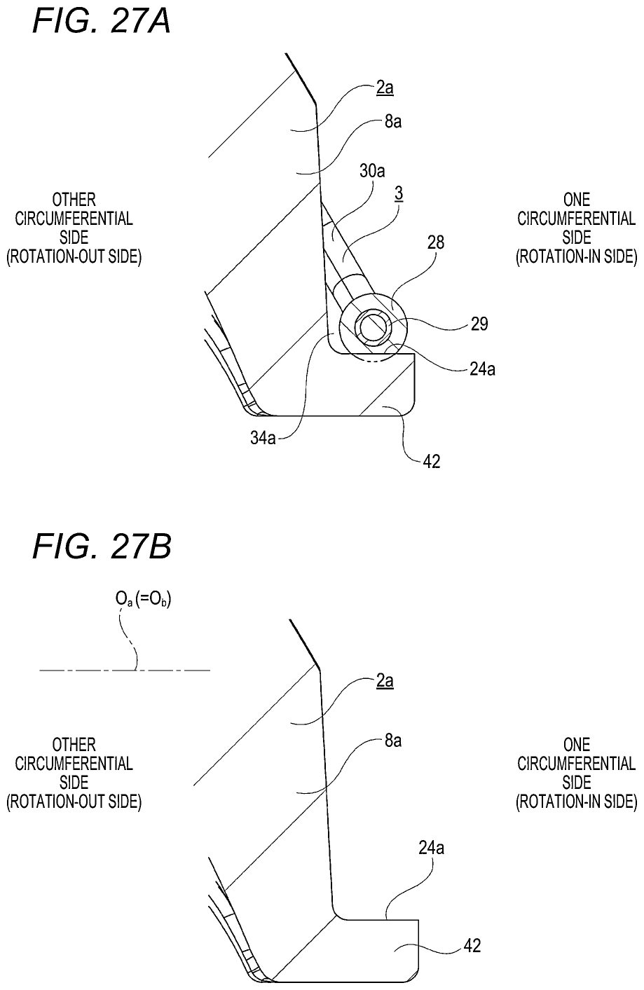

Specifically, the cover tube 28 is in contact with only the contact surface 24a of the caliper 2a which is provided on the rotation-in-side coupling portion 8a and which faces a radially outer side, and is pressed against the contact surface 24a toward the radially inner side (lower side in FIG. 25 and FIG. 27A and back side in FIG. 26A) substantially orthogonal to the central axis directions of the flare nuts 27a and 27b. Therefore, the cover tube 28 is pressed against the caliper 2a only radially inward, and is in contact with the caliper 2a only with a radial fastening margin. Therefore, the cover tube 28 does not have fastening margins with respect to the caliper 2a in the circumferential direction that substantially coincides with the central axis directions of the flare nuts 27a and 27b. A gap 34a is provided between the cover tube 28 and the caliper 2a in the central axis directions of the flare nuts 27a and 27b.

Only a radially inner portion of the cover tube 28 in contact with the contact surface 24a is elastically deformed. In this example, since an axial dimension of the cover tube 28 is smaller than the axial width of the contact surface 24a, the entire cover tube 28 in an axial direction comes into contact with the contact surface 24a and is elastically deformed.

Similarly, in the case of this example as described above, the cover tube 28 is not pressed against the caliper 2a in the central axis directions of the flare nuts 27a and 27b, but is pressed against the contact surface 24a of the caliper 2a only on the radially inner side substantially perpendicular to the central axis directions of the flare nuts 27a and 27b. Accordingly, the cover tube 28 has only the radial fastening margin, and does not have the fastening margin in the central axis directions (circumferential direction) of the flare nuts 27a and 27b.

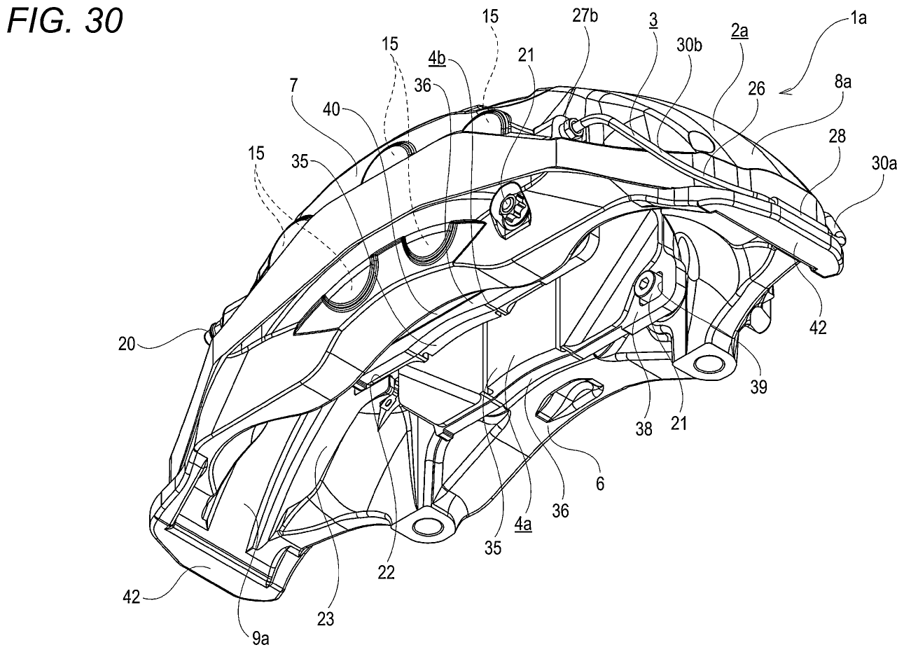

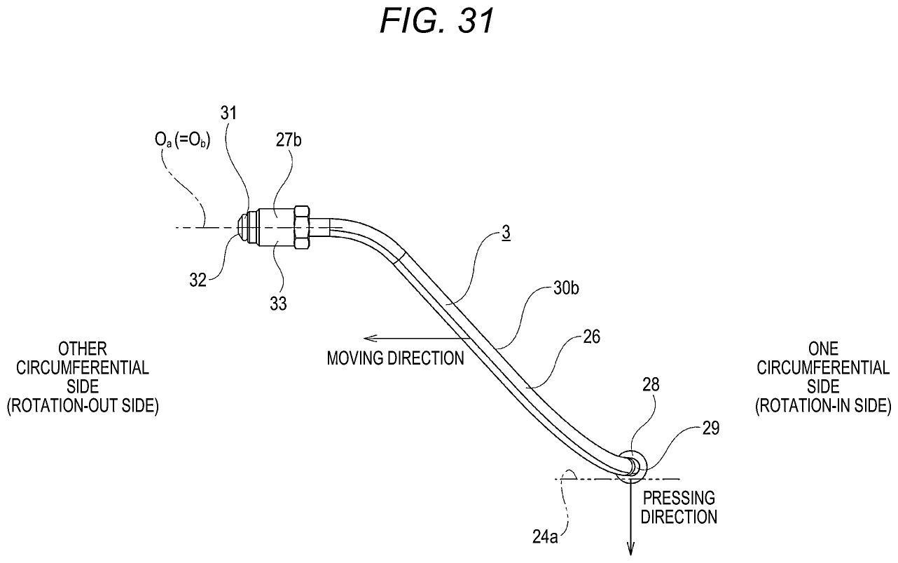

Therefore, as shown in FIG. 31, when the entire communication pipe 3 is moved to the other circumferential side in order to respectively screw and connect the flare nuts 27a and 27b to the inner body 6 and the outer body 7, it is not necessary to increase an elastic deformation amount of the cover tube 28 with respect to the contact surface 24a. Accordingly, it is not necessary to increase tightening torque when the flare nuts 27a and 27b are screwed and connected. Further, since the cover tube 28 has only the radial fastening margin and does not have the fastening margin in the central axis directions of the flare nuts 27a and 27b, a tensile stress applied to a connection portion between the communication pipe 3 and the caliper 2a can be reduced as compared with the structure in the related art.

Similarly, in the case of this example, since the contact surface 24a is arranged substantially parallel to the central axes Oa and Ob of the flare nuts 27a and 27b, the elastic deformation amount of the cover tube 28 with respect to the contact surface 24a when the communication pipe 3 is moved to the other circumferential side can be constant.

Further, during a connection work of the communication pipe 3, the cover tube 28 can be moved in any direction other than the radially inner side without being limited by the caliper 2a. Therefore, even when there is a dimensional variation or the like in the pipe body 26, the variation can be absorbed by moving the cover tube 28. Therefore, from this point of view, it is also possible to improve efficiency of an assembly work of the opposed piston type disc brake device 1a.

Other configurations, operations, and effects are the same as those of the first embodiment.

### Third Embodiment

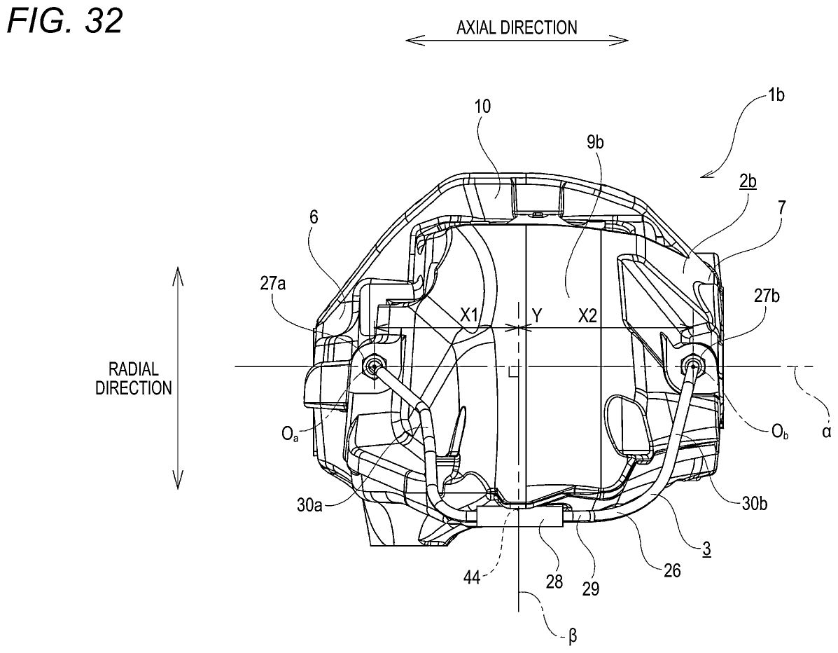

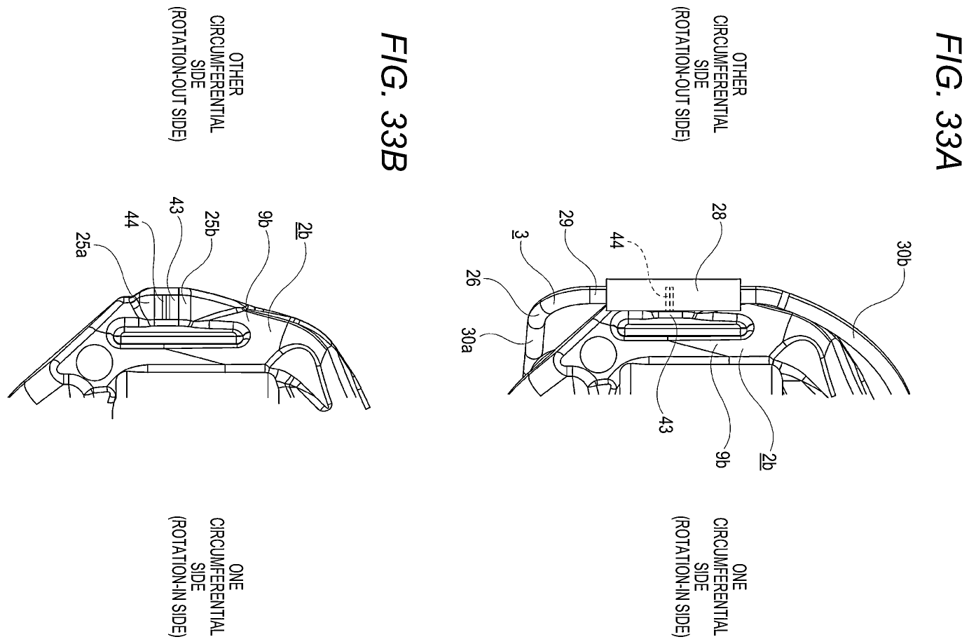

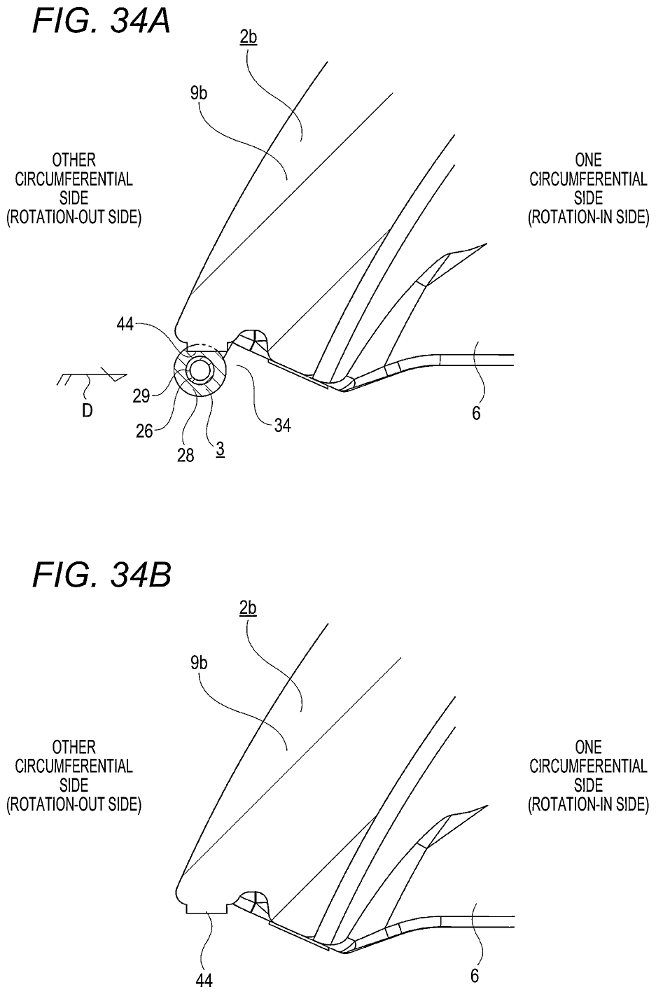

A third embodiment will be described with reference to FIGS. 32 to 35.

In an opposed piston type disc brake device 1b according to this example, a contact mode of the cover tube 28 with respect to a caliper 2b is different from the first embodiment.

The caliper 2b includes a surface 43 facing a radially inner side at an axially intermediate portion of an end portion on the other circumferential side of the rotation-out-side coupling portion 9b. Further, a protuberance 44 protruding inward in the radial direction, which is a direction orthogonal to central axis directions of the flare nuts 27a and 27b, is provided at an axially intermediate portion of the surface 43. In the illustrated example, the surface 43 is formed in a planar shape, and only one protuberance 44 is provided on the surface 43. However, a surface can be formed from a surface other than a flat surface, and a plurality of protuberances can be provided.

In the illustrated example, the protuberance 44 has a triangular prism shape and extends in a circumferential direction. An axial width of the protuberance 44 decreases toward the radially inner side. A shape of the protuberance is not limited to a triangular prism shape, and may be a quadrangular prism shape, a cylindrical shape (including a semi-cylindrical shape), or the like.

In the illustrated example, a protruding amount of the protuberance 44 in the radial direction is constant in the circumferential direction and is smaller than a wall thickness of the cover tube 28. However, the protruding amount of the protuberance 44 may be changed in relation to the circumferential direction, for example, by increasing toward one circumferential side.

As shown in FIG. 32, the protuberance 44 is disposed on an orthogonal plane β which passes through a position (Y) where distances (X1, X2) to the respective central axes Oa and Ob of the pair of flare nuts 27a and 27b are equal to each other in a virtual plane α including the respective central axes Oa and Ob of the pair of flare nuts 27a and 27b constituting the communication pipe 3 and which is orthogonal to the virtual plane α.

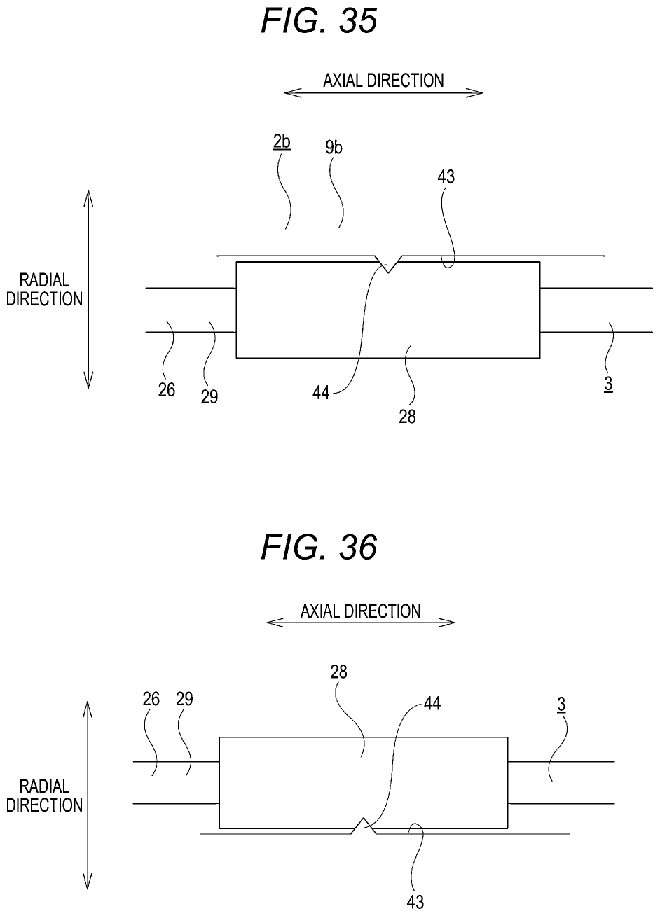

In this example, the cover tube 28 is in contact with the protuberance 44 of the caliper 2b which is provided on the rotation-out-side coupling portion 9b, and is pressed against the protuberance 44 toward a radially outer side (upper side in FIGS. 32 and 35) substantially orthogonal to the central axis directions of the flare nuts 27a and 27b. Therefore, the cover tube 28 is pressed against the caliper 2b only radially outward, and is in contact with the caliper 2b only with a radial fastening margin. Therefore, the cover tube 28 does not have fastening margins in the circumferential direction that substantially coincides with the central axis directions of the flare nuts 27a and 27b.

In this example, the cover tube 28 is pressed against only the protuberance 44 and is in contact therewith. However, portions on both axial sides of a portion of the cover tube 28 in contact with the protuberance 44 may be brought into contact with the surface 43 (pressed radially outward).

In this example as described above, since the cover tube 28 is pressed against the protuberance 44 of the caliper 2b, it is possible to increase surface pressure with respect to the caliper 2b compared to a case in which the cover tube 28 is pressed against a flat surface. Therefore, an elastic deformation amount of the cover tube 28 can be increased, and the fastening margin of the cover tube 28 with respect to the caliper 2b can be increased. Therefore, even when the pipe body 26 of the communication pipe 3 has a variation in dimension, the cover tube 28 can be pressed against the caliper 2b with sufficiently large force, and the cover tube 28 can be effectively suppressed from floating from the caliper 2b.

In this example, since the protuberance 44 is disposed on the orthogonal plane β, it is possible to sufficiently increase dimensions (X1, X2) of portions of the pipe body 26 that are present on both axial sides of the protuberance 44. Therefore, it is possible to easily deform the portions of the pipe body 26 that are present on both the axial sides of the protuberance 44, and thus even if there is the dimensional variation in the pipe body 26, it is possible to suppress workability of a connection work of the communication pipe 3 from decreasing.

In this example, a case in which the protuberance 44 protruding radially inward is provided has been described, but as in a modification illustrated in FIG. 36, it is also possible to press the cover tube 28 radially inward against the protuberance 44 protruding radially outward.

### Fourth Embodiment

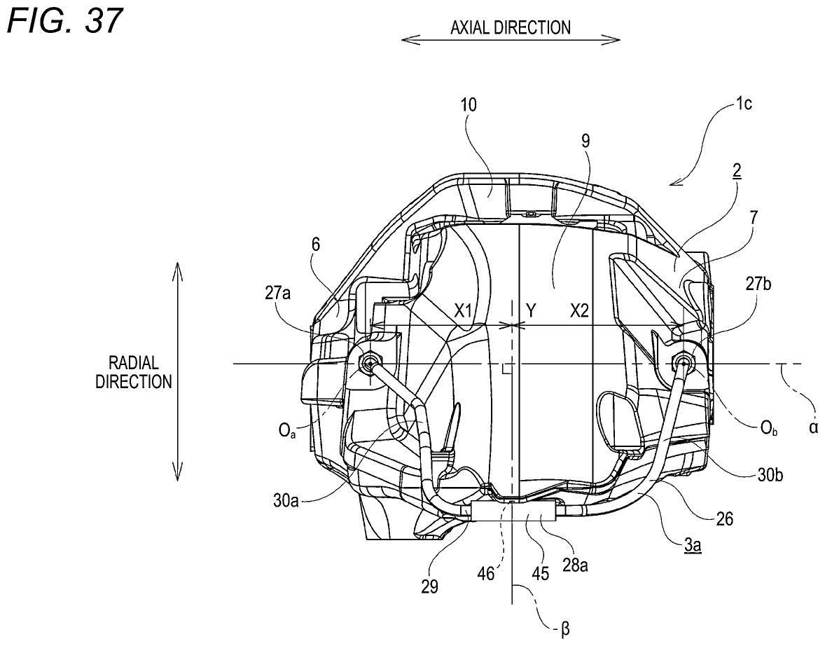

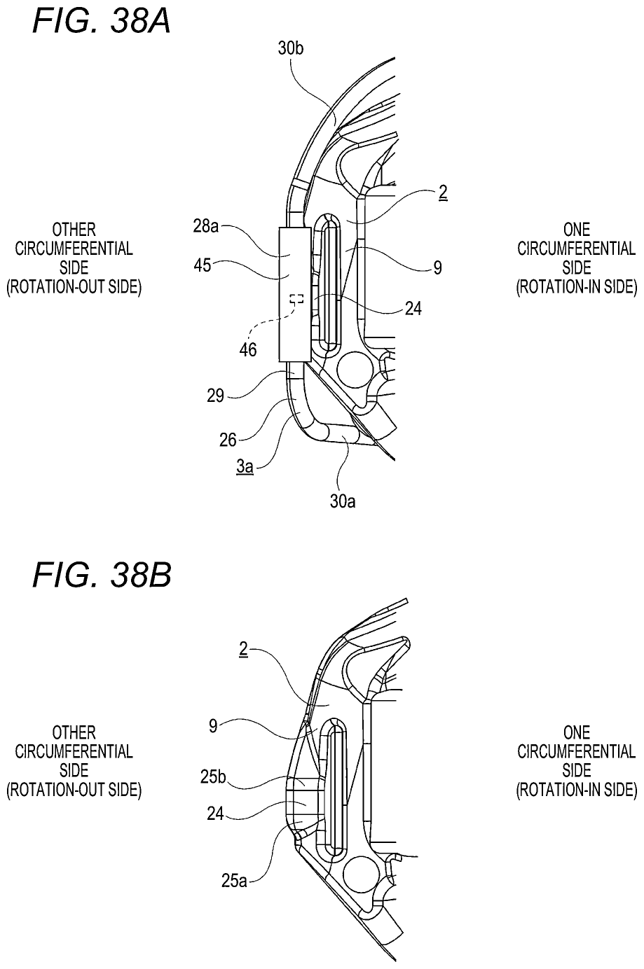

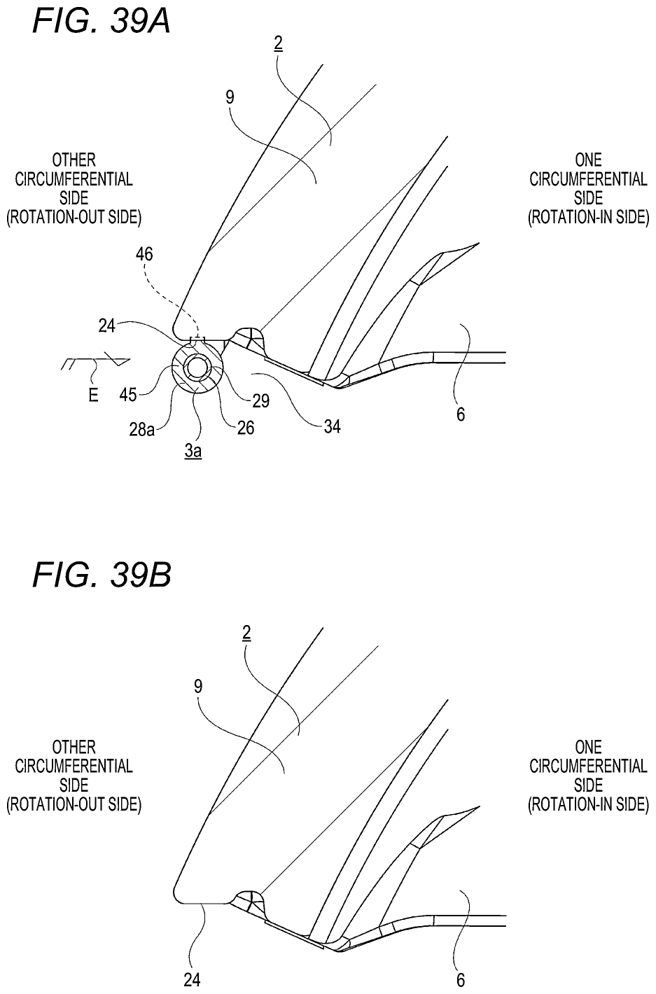

A fourth embodiment will be described with reference to FIGS. 37 to 40.

In an opposed piston type disc brake device 1c according to this example, a contact mode of a cover tube 28a with respect to the caliper 2 is different from the first embodiment.

Similarly to the structure of the first embodiment, the caliper 2 in this example includes a planar contact surface 24 facing radially inward at an axially intermediate portion of an end portion on the other circumferential side of the rotation-out-side coupling portion 9.

In this example, the cover tube 28a constituting the communication pipe 3a includes a tube body 45 having a cylindrical shape and a protuberance 46.

The tube body 45 covers an axially intermediate portion of the axially extending portion 29 constituting the pipe body 26.

The protuberance 46 is provided at one location in a circumferential direction of an axially intermediate portion of an outer peripheral surface of the tube body 45. In this example, the protuberance 46 is provided on an end portion on a radially outer side of the outer peripheral surface of the tube body 45. That is, the protuberance 46 protrudes outward in a radial direction, which is a direction orthogonal to central axis directions of the flare nuts 27a and 27b, from the outer peripheral surface of the tube body 45. In the illustrated example, only one protuberance 46 is provided at the axially intermediate portion of the outer peripheral surface of the tube body 45, but a plurality of protuberances 46 may be provided.

In the illustrated example, the protuberance 46 has a quadrangular prism shape. A shape of the protuberance is not limited to the quadrangular prism shape, and may be a triangular prism shape, a pyramid shape, a cylindrical shape (including a semi-cylindrical shape), a conical shape, a hemispherical shape, or the like.

In the illustrated example, a radial height of the protuberance 46 (radial distance from a virtual plane including a central axis of the cover tube 28a) is constant over an entire circumference. However, a radial height of the protuberance 46 can also be changed in the circumferential direction, such as increasing toward one circumferential side.

As shown in FIG. 37, the protuberance 46 is disposed on the orthogonal plane β which passes through the position (Y) where the distances (X1, X2) to the respective central axes Oa and Ob of the pair of flare nuts 27a and 27b are equal to each other in the virtual plane α including the respective central axes Oa and Ob of the pair of flare nuts 27a and 27b constituting the communication pipe 3a and which is orthogonal to the virtual plane α.

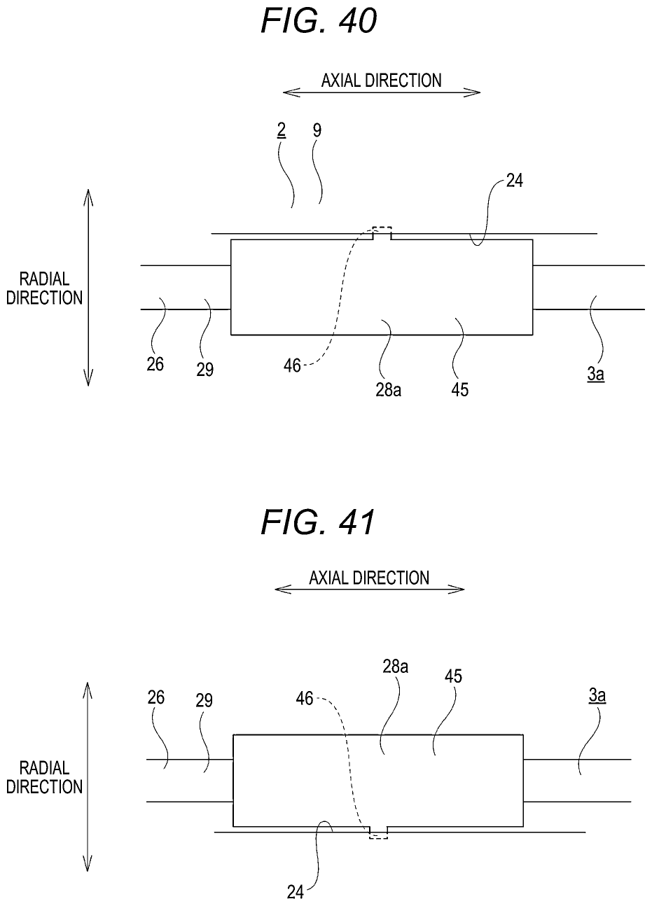

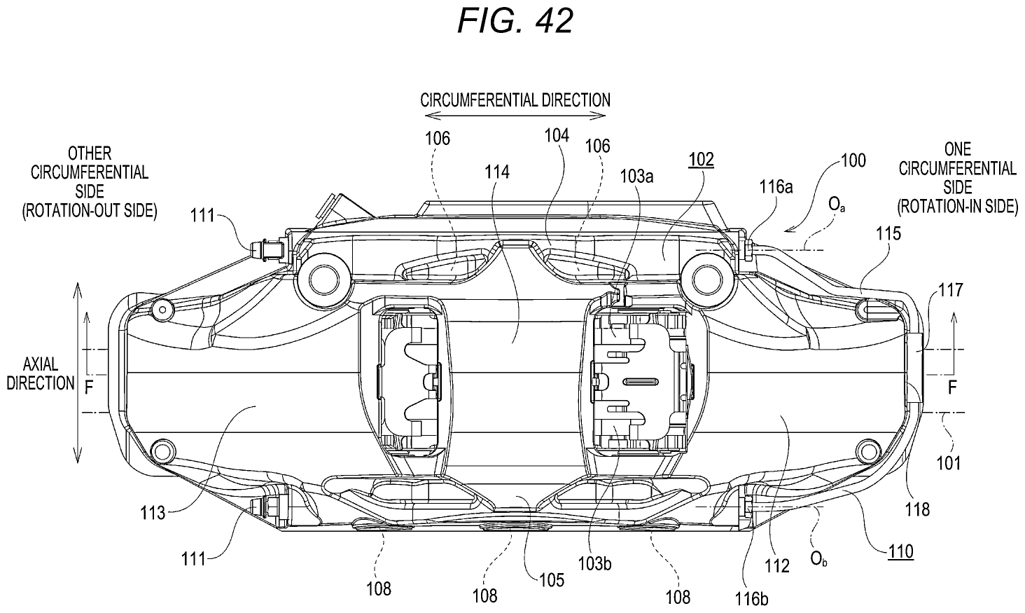

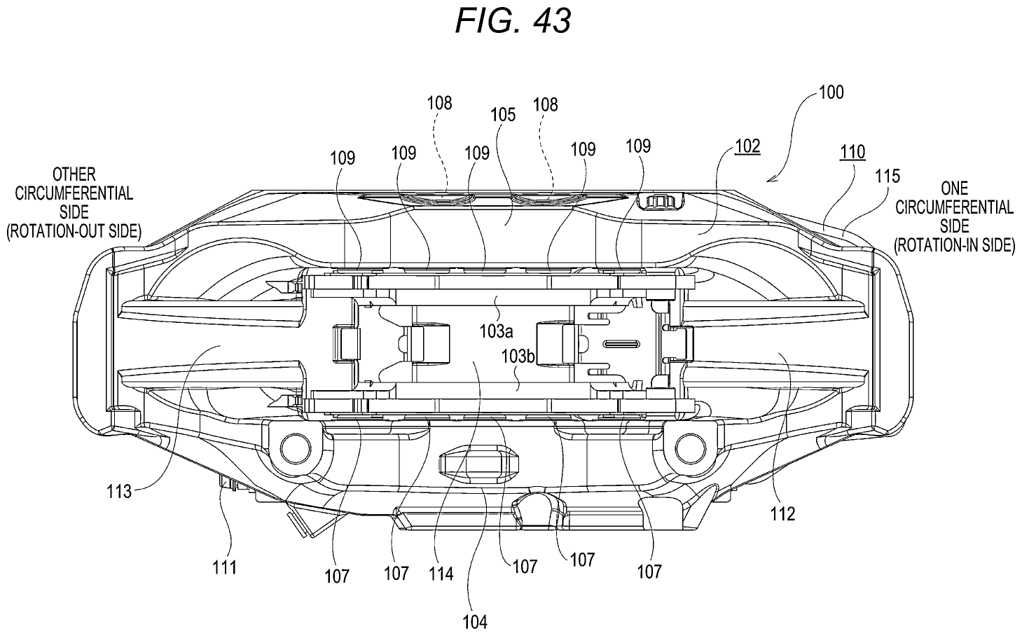

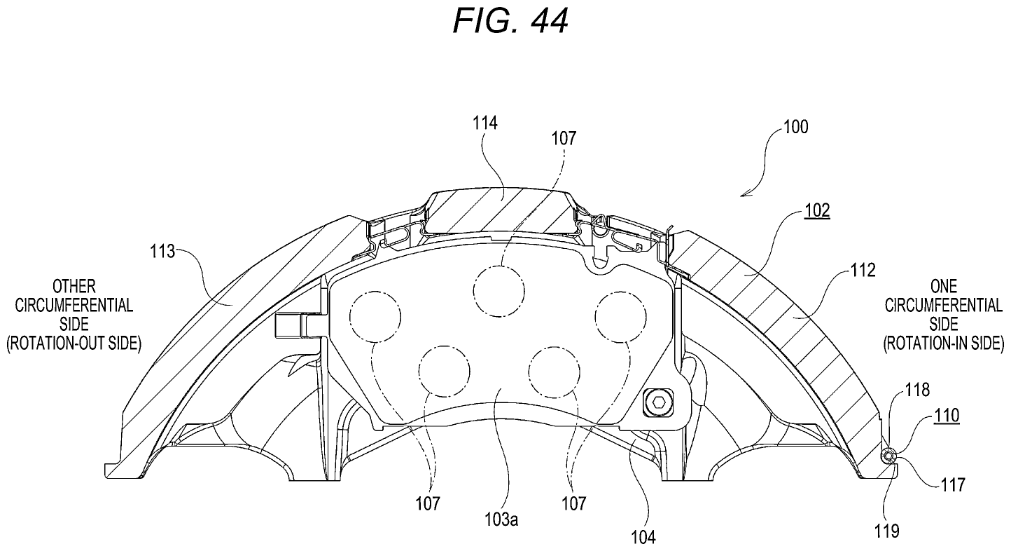

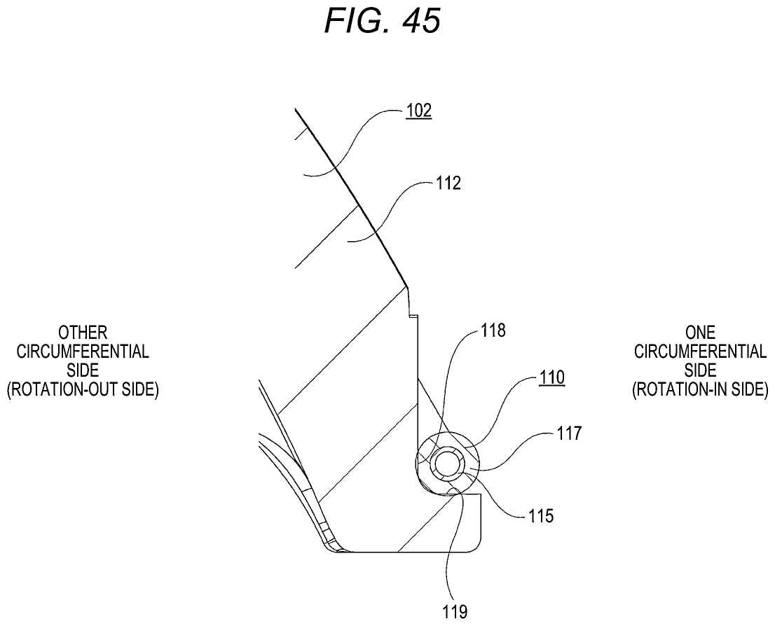

In this example, the protuberance 46 of the cover tube 28a is in contact with the contact surface 24 provided on the rotation-out-side coupling portion 9, and is pressed against the contact surface 24 toward the radially outer side (upper side in FIGS. 37 and 40) substantially orthogonal to the central axis directions of the flare nuts 27a and 27b. Therefore, the cover tube 28a is pressed against the caliper 2 only radially outward, and is in contact with the caliper 2 only with a radial fastening margin. Therefore, the cover tube 28a does not have fastening margins with respect to the caliper 2 in the circumferential direction that substantially coincides with the central axis directions of the flare nuts 27a and 27b.

In this example, only the protuberance 46 of the cover tube 28a is in contact with the contact surface 24, and a portion of the outer peripheral surface of the tube body 45 that is deviated from the protuberance 46 is not in contact with the contact surface 24. However, portions of the outer peripheral surface of the tube body 45 present on both axial sides of the protuberance 46 may be brought into contact with the contact surface 24 (pressed radially outward).

In this example as described above, since the protuberance 46 of the cover tube 28a is pressed against the contact surface 24 of the caliper 2, it is possible to increase surface pressure on the caliper 2 compared to a case in which a cylindrical outer peripheral surface is pressed against a planar contact surface. Therefore, the cover tube 28a can be elastically deformed largely, and the fastening margin of the cover tube 28a with respect to the caliper 2 can be increased. Therefore, even when the pipe body 26 of the communication pipe 3a has a variation in dimension, the cover tube 28a can be pressed against the caliper 2 with sufficiently large force, and the cover tube 28a can be effectively suppressed from floating from the caliper 2.

In this example, since the protuberance 46 is disposed on the orthogonal plane β, it is possible to sufficiently increase dimensions (X1, X2) of portions of the pipe body 26 that are present on both the axial sides of the protuberance 46. Therefore, it is possible to easily deform the portions of the pipe body 26 that are present on both the axial sides of the protuberance 46, and thus even if there is the dimensional variation in the pipe body 26, it is possible to suppress workability of a connection work of the communication pipe 3a from decreasing.

Other configurations, operations, and effects are the same as those of the first embodiment and the third embodiment.

In this example, the case has been described in which the protuberance 46 provided on the outer peripheral surface of the cover tube 28a is pressed against the contact surface 24 facing radially inward, but as in a modification shown in FIG. 41, the protuberance 46 provided on the outer peripheral surface of the cover tube 28a can also be pressed radially inward against the contact surface 24 facing radially outward.

Although the embodiments of the present invention have been described above, the present invention is not limited thereto, and can be appropriately changed without departing from the technical concept of the invention. Further, the structures of the embodiments can be appropriately combined and implemented as long as no contradiction occurs.

The technical concept of the present invention is not limited to the structure in which the central axes of the pair of flare nuts constituting the communication pipe are disposed in the circumferential direction of the rotor, and can also be applied to a structure in which the central axes are disposed in other directions such as the radial direction of the rotor.

In the case of implementing the present invention, the number and the arrangement of the inner cylinders and the outer cylinders are not limited to the structures of the respective embodiments, and can be appropriately changed.

As described above, an opposed piston type disc brake device according to one aspect of the present invention includes a caliper and a communication pipe.

The caliper includes an inner body including an inner cylinder, and an outer body including an outer cylinder.

The communication pipe is disposed around the caliper and connects the inner cylinder and the outer cylinder.

The communication pipe includes a pipe body, a pair of flare nuts which are provided on end portions of the pipe body on both sides in a manner of being rotatable relative to the pipe body in a state in which central axes of the flare nuts are arranged substantially parallel to each other, and which are respectively screwed and connected to the inner body and the outer body, and a cover tube which covers a part of the pipe body and is in contact with the caliper with a fastening margin, the cover tube being made of an elastic material.

In the opposed piston type disc brake device according to the aspect of the present invention, the cover tube does not have the fastening margin with respect to the caliper in a central axis direction of each of the flare nuts.

In the present specification and claims, “substantially parallel” means not only completely parallel but also almost parallel.

In the opposed piston type disc brake device according to the aspect of the present invention, a gap can be provided between the cover tube and the caliper in the central axis direction of the flare nut.

Alternatively, in the opposed piston type disc brake device according to the aspect of the present invention, the cover tube and the caliper may be brought into contact with each other (zero touch) without the fastening margin in the central axis direction of the flare nut.

In the opposed piston type disc brake device according to the aspect of the present invention, the cover tube can be pressed against the caliper only in one predetermined direction other than the central axis direction of the flare nut.

Alternatively, in the opposed piston type disc brake device according to the aspect of the present invention, the cover tube may be pressed against the caliper in a plurality of predetermined directions other than the central axis direction of the flare nut.

In the opposed piston type disc brake device according to the aspect of the present invention, the cover tube can be pressed against the caliper in a direction substantially orthogonal to the central axis direction of the flare nut.

In the present specification and claims, the “substantially orthogonal direction” includes not only a completely orthogonal direction but also an almost orthogonal direction. Specifically, the case in which an angular deviation with respect to a completely orthogonal direction is 15 degrees or less is included.

In the opposed piston type disc brake device according to the aspect of the present invention, the central axis direction of the flare nut can substantially coincide with a circumferential direction, and the cover tube can be pressed against a surface of the caliper facing radially outward.

Alternatively, the central axis direction of the flare nut may substantially coincide with the circumferential direction, and the cover tube may be pressed against a surface of the caliper facing radially inward.

Alternatively, the central axis direction of the flare nut may substantially coincide with the circumferential direction, and the cover tube may be pressed against a surface of the caliper facing axially inward or a surface facing axially outward of the caliper.

In the present specification and claims, the “substantially coincide” means not only completely coincide but also almost coincide.

In the opposed piston type disc brake device according to the aspect of the present invention, the central axis direction of the flare nut may substantially coincide with a radial direction.

In the opposed piston type disc brake device according to the aspect of the present invention, the caliper can further include a coupling portion that couples a circumferential end portion of the inner body to a circumferential end portion of the outer body, and the cover tube can be pressed against the coupling portion.

In the opposed piston type disc brake device according to the aspect of the present invention, the cover tube may be pressed against the inner body, the outer body, or another portion of the caliper.

In the opposed piston type disc brake device according to the aspect of the present invention, a surface of the caliper with which the cover tube is in contact while having the fastening margin, can be a flat surface.

In the opposed piston type disc brake device according to the aspect of the present invention, the surface of the caliper with which the cover tube is in contact while having the fastening margin may be an uneven surface having an uneven shape, a stepped surface having a step shape, or a curved surface having a curved shape in a cross section orthogonal to the central axis of the flare nut.

In the opposed piston type disc brake device according to the aspect of the present invention, the central axis of each of the pair of flare nuts and the surface of the caliper with which the cover tube is in contact while having the fastening margin, can be arranged substantially parallel to each other.

In the opposed piston type disc brake device according to the aspect of the present invention, the cover tube may have a cylindrical shape in a free state.

Alternatively, in the opposed piston type disc brake device according to the aspect of the present invention, the cover tube may have a polygonal tube shape in a free state.

In the opposed piston type disc brake device according to the aspect of the present invention, the caliper can include a protuberance at a portion in contact with the cover tube.

In the opposed piston type disc brake device according to the aspect of the present invention, the cover tube can include a protuberance at a portion in contact with the caliper.

In the opposed piston type disc brake device according to the aspect of the present invention, the protuberance can protrude in a direction substantially orthogonal to the central axis direction of the flare nut.

In the opposed piston type disc brake device according to the aspect of the present invention, the protuberance can be disposed on an orthogonal plane that passes through a position where distances to the respective central axes of the pair of flare nuts are equal to each other in a virtual plane including the central axes of the pair of flare nuts and that is orthogonal to the virtual plane.

In the opposed piston type disc brake device according to the aspect of the present invention, the protuberance may have any one of a prism shape (including a triangular prism shape, a quadrangular prism shape, and the like), a pyramid shape (including a triangular pyramid shape, a quadrangular pyramid shape, and the like), a cylindrical shape (including a semi-cylindrical shape), a conical shape, and a hemispherical shape.

In the opposed piston type disc brake device according to the aspect of the present invention, one or a plurality of the protuberances may be provided on either the caliper or the cover tube, or one or a plurality of the protuberances may be provided on each of the caliper and the cover tube.

In the opposed piston type disc brake device according to the aspect of the present invention, the cover tube can include a tube body covering the pipe body and the protuberance provided on a surface of the tube body.

In this case, a wall thickness of the tube body can be larger than a wall thickness of the protuberance.

In the opposed piston type disc brake device according to the aspect of the present invention, dimensions of the tube body and the protuberance in an axial direction of the tube body may be different from each other or may be the same as each other.

According to an opposed piston type disc brake device according to one aspect of the present invention, efficiency of an assembly work can be improved as compared with the related art while suppressing a communication pipe from floating with respect to a caliper, and a tensile stress applied to a connection portion between the communication pipe and the caliper can be reduced.

What is claimed is:

1. An opposed piston type disc brake device comprising:
a caliper including an inner body including an inner cylinder, and an outer body including an outer cylinder; and
a communication pipe disposed around the caliper and connecting the inner cylinder and the outer cylinder, wherein
the communication pipe includes a pipe body, a pair of flare nuts which are provided on end portions of the pipe body on both sides in a manner of being rotatable relative to the pipe body in a state in which central axes of the flare nuts are arranged substantially parallel to each other, and which are respectively screwed and connected to the inner body and the outer body, and a cover tube which covers a part of the pipe body and is in contact with the caliper with a fastening margin, the cover tube being made of an elastic material, and
the cover tube does not have the fastening margin with respect to the caliper in a central axis direction of each of the flare nuts.

2. The opposed piston type disc brake device according to claim 1, wherein
a gap is provided between the cover tube and the caliper in the central axis direction of the flare nut.

3. The opposed piston type disc brake device according to claim 1, wherein
the cover tube is pressed against the caliper only in one predetermined direction other than the central axis direction of the flare nut.

4. The opposed piston type disc brake device according to claim 3, wherein
the cover tube is pressed against the caliper in a direction substantially orthogonal to the central axis direction of the flare nut.

5. The opposed piston type disc brake device according to claim 4, wherein
the central axis direction of the flare nut substantially coincides with a circumferential direction, and
the cover tube is pressed against a surface of the caliper facing radially outward.

6. The opposed piston type disc brake device according to claim 4, wherein
the central axis direction of the flare nut substantially coincides with a circumferential direction, and
the cover tube is pressed against a surface of the caliper facing radially inward.

7. The opposed piston type disc brake device according to claim 1, wherein
the caliper further includes a coupling portion that couples a circumferential end portion of the inner body to a circumferential end portion of the outer body, and
the cover tube is pressed against the coupling portion.

8. The opposed piston type disc brake device according to claim 1, wherein
a surface of the caliper with which the cover tube is in contact while having the fastening margin, is a flat surface.

9. The opposed piston type disc brake device according to claim 8, wherein
the central axis of each of the pair of flare nuts and the surface of the caliper with which the cover tube is in contact while having the fastening margin, are arranged substantially parallel to each other.

10. The opposed piston type disc brake device according to claim 1, wherein
the caliper includes a protuberance at a portion in contact with the cover tube.

11. The opposed piston type disc brake device according to claim 1, wherein
the cover tube includes a protuberance at a portion in contact with the caliper.

12. The opposed piston type disc brake device according to claim 10, wherein
the protuberance protrudes in a direction substantially orthogonal to the central axis direction of the flare nut.

13. The opposed piston type disc brake device according to claim 10, wherein
the protuberance is disposed on an orthogonal plane that passes through a position where distances to the respective central axes of the pair of flare nuts are equal to each other in a virtual plane including the central axes of the pair of flare nuts and that is orthogonal to the virtual plane.
